(19) United States
(12) Patent Application Publication
(10) Pub. No.: US 2021/0258470 A1
(43) Pub. Date: Aug. 19, 2021

(54) MOBILE BODY AND CONTROL METHOD

(71) Applicant: SONY CORPORATION, TOKYO (JP)

(72) Inventors: YUSUKE KUDO, TOKYO (JP); KUNIAKI TORII, TOKYO (JP); MIKIO NAKAI, TOKYO (JP)

(21) Appl. No.: 17/250,180

(22) PCT Filed: Jun. 5, 2019
(86) PCT No.: PCT/JP2019/022260

§ 371 Date: Dec. 10, 2020

(30) Foreign Application Priority Data
Jun. 18, 2018 (JP) 2018-115480

(51) Int. Cl. H04N 5/232; B64C 39/02; G06K 9/00

(52) U.S. Cl. CPC H04N 5/23206; B64C 39/024; H04N 5/23212; B64C 2201/146; G06K 9/00664; B64C 2201/127; H04N 5/23218

(57) ABSTRACT

The present technique relates to a mobile body and a control method by which multiple mobile bodies that are performing photographing can be inhibited from obstructing each other's photographing. The mobile body receives photographing information including information regarding a photographing range which is photographed by another mobile body. Subsequently, the mobile body controls a photographing action of a camera for performing photographing, according to the photographing information regarding the other mobile body. The present technique is applicable to, for example, a photographing system that performs aerial photographing using multiple drones, or the like.

### TECHNICAL FIELD

The present technique relates to a mobile body and a control method, and particularly, relates to a mobile body and a control method for preventing a plurality of photographing mobile bodies from causing mutual obstruction of photographing, for example.

### BACKGROUND ART

In recent years, a technology of performing photographing by means of a camera installed in an unmanned aerial vehicle which is called a drone has been proposed (for example, see PTL 1).

### CITATION LIST

### Patent Literature

### [PTL 1]

International Publication No. WO 2016/059877

### SUMMARY

### Technical Problem

In a case where multiple camera-equipped drones or other mobile bodies (hereinafter, also referred to as camera robots) each autonomously photograph a subject, that is, in a case where, for example, multiple camera robots autonomously track and photograph the subject, the camera robots obstruct each other's photographing in some cases.

For example, in some cases, one camera robot enters a photographing range of another camera robot, so that the one camera robot appears in an image photographed by the other camera robot.

The present technique has been achieved in view of the above circumstances, and can inhibit multiple mobile bodies from causing mutual obstruction of photographing.

### Solution to Problem

A mobile body according to the present technique includes a communication section that receives photographing information including information regarding a photographing range which is photographed by another mobile body, and a photographing action control section that controls a photographing action of a camera according to the photographing information regarding the other mobile body received by the communication section.

A control method according to the present technique includes, by the mobile body, receiving photographing information including information regarding a photographing range which is photographed by another mobile body, and controlling a photographing action of a camera according to the photographing information regarding the other mobile body.

In the mobile body and the control method according to the present technique, photographing information including information regarding a photographing range which is photographed by another mobile body is received, and a photographing action of a camera is controlled according to the photographing information regarding the other mobile body.

It is to be noted that the control method according to the present technique can be implemented by causing a computer to execute a program. Such a program can be distributed by being transmitted via a transmission medium or by being recorded in a recording medium.

### Advantageous Effects of Invention

According to the present technique, multiple mobile bodies that are performing photographing can be inhibited from causing mutual obstruction of photographing.

It is to be noted that the above effects are not necessarily limitative, and any of effects described in the present disclosure may be provided.

### BRIEF DESCRIPTION OF DRAWINGS

FIG. 1 is a diagram depicting a configuration example of one embodiment of a photographing system to which the present technique is applied.

FIG. 2 is a diagram for explaining the outline of an example of a photographing action that does not involve obstruction of photographing.

FIG. 3 is a diagram for explaining the outline of another example of a photographing action that does not involve obstruction of photographing.

FIG. 4 depicts diagrams for explaining the outline of obstruction cost setting.

FIG. 5 is a diagram for explaining a shielded range.

FIG. 6 is a block diagram depicting a configuration example of a camera robot 20ᵢ.

FIG. 7 is a diagram for explaining the outline of processes at the camera robot 20ᵢ.

FIG. 8 is a diagram for explaining an example of a first photographing condition in which the camera robot 20ᵢ obstructs photographing being performed by another camera robot 20ₖ.

FIG. 9 is a diagram for explaining an example of a second photographing condition in which the camera robot 20ᵢ obstructs photographing being performed by the other camera robot 20ₖ.

FIG. 10 is a diagram for explaining an example of a third photographing condition in which the camera robot 20ᵢ obstructs photographing being performed by the other camera robot 20ₖ.

FIG. 11 is a diagram for explaining an example of a photographing action to inhibit the camera robot 20ᵢ from appearing in an image being photographed by the camera robot 20ₖ under the first photographing condition.

FIG. 12 is a diagram for explaining an example of processes at the camera robots 20ᵢ and 20ₖ in a case where a photographing action to inhibit the camera robot 20ᵢ from appearing in an image being photographed by the camera robot 20ₖ is conducted under the first photographing condition.

FIG. 13 is a diagram for explaining an example in which the camera robot 20ₖ serving as a bird's-eye-view camera robot sets a predicted photographing range.

FIG. 14 is a diagram for explaining an example of cost information combining at a cost information combining section 33.

FIG. 15 is a diagram for explaining correcting an optimum photographing position.

FIG. 16 is a diagram for explaining an example of a photographing action to inhibit the camera robot 20ᵢ from appearing in an image being photographed by the camera robot 20ₖ under the second photographing condition.

FIG. 17 is a diagram for explaining an example of process at the camera robots 20ᵢ and 20ₖ in a case where a photographing action to inhibit the camera robot 20ᵢ from appearing in an image being photographed by the camera robot 20ₖ is conducted under the second photographing condition.

FIG. 18 is a diagram for explaining another example of processes at the camera robots 20ᵢ and 20ₖ in a case where a photographing action to inhibit the camera robot 20ᵢ from appearing in an image being photographed by the camera robot 20ₖ is conducted under the second photographing condition.

FIG. 19 is a diagram for explaining an example of a predicted photographing range and obstruction costs that are set by the camera robot 20ₖ serving as a ball-tracking camera robot according to a photographing target.

FIG. 20 is a diagram for explaining an example of a photographing action to inhibit the camera robots 20ᵢ and 20ₖ from appearing in each other's photographed images under the third photographing condition.

FIG. 21 is a diagram for explaining an example of processes at the camera robots 20ᵢ and 20ₖ in a case where a photographing action to inhibit the camera robots 20ᵢ and 20ₖ from appearing in each other's photographed images under the third photographing condition.

FIG. 22 is a diagram for explaining setting obstruction costs according to an attention region.

FIG. 23 is a diagram for explaining setting obstruction costs according to a focal distance.

FIG. 24 is a diagram for explaining setting obstruction costs according to a shielded range.

FIG. 25 is a diagram for explaining a case in which a range that is apart from a photographing range is set as a predicted photographing range.

FIG. 26 is a block diagram depicting a configuration example of one embodiment of a computer to which the present technique is applied.

### DESCRIPTION OF EMBODIMENT

<One Embodiment of Photographing System to which Present Technique is Applied>

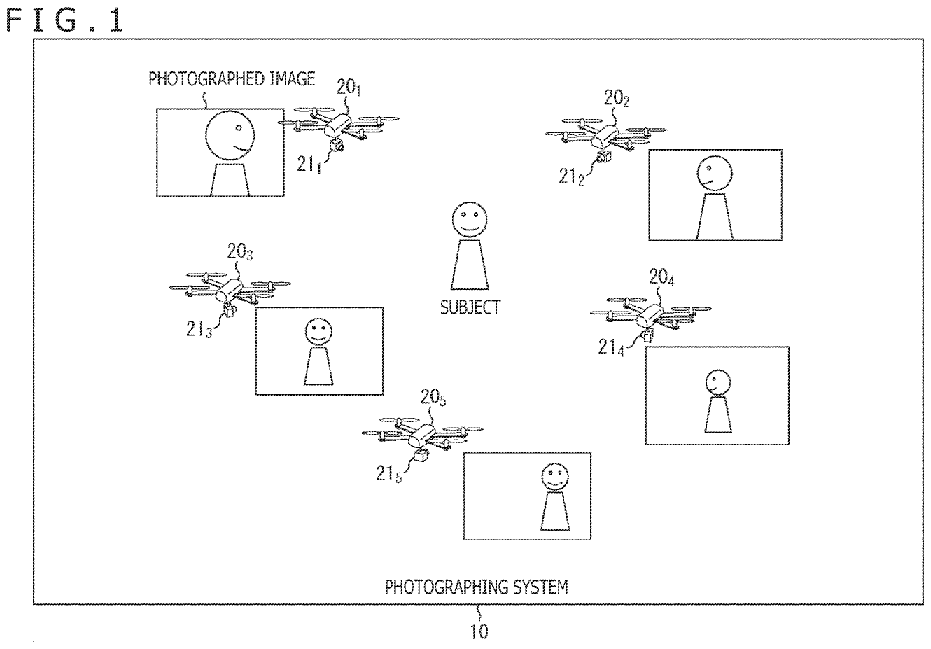

FIG. 1 is a diagram depicting a configuration example of one embodiment of a photographing system to which the present technique is applied.

In FIG. 1, a photographing system 10 includes five camera robots 20₁, 20₂, 20₃, 20₄, and 20₅.

It is to be noted that the number of camera robots 20ᵢ included in the photographing system 10 is not limited to five, and any number more than two other than five may be adopted.

In FIG. 1, the camera robot 20ᵢ includes a drone (unmanned aerial vehicle), for example, and is capable of moving in a three-dimensional space of the real world. The camera robot 20ᵢ is equipped with a camera 21ᵢ, and photographs a subject by means of the camera 21ᵢ while moving in a three-dimensional space. That is, the camera robot 20ᵢ performs photographing while moving so as to track a subject.

Besides drones, here, any mobile body can be adopted as the camera robot 20ᵢ. For example, a four-wheeled or two-wheeled vehicle type mobile body, a bipedal or quadrupedal robot, or the like, can be adopted as the camera robot 20ᵢ.

Further, the camera 21ᵢ may include an image sensor which receives visible light, or may include a ranging sensor (e.g., a ToF (Time of Flight) sensor) which receives non-visible light such as infrared light.

Also, an action that is conducted by the camera robot 20ᵢ for photographing with the camera 21ᵢ is also referred to as a photographing action. Examples of the photographing action include a movement of the camera robot 20ᵢ to a prescribed position such that photographing of a subject is performed from the prescribed position, and a camera control on the camera angle (attitude), the zoom (angle of view), or the like of the camera 21ᵢ.

In the photographing system 10 in FIG. 1, the camera robots 20₁ to 20₅ each set a movement path to track a subject, as appropriate, and perform photographing while moving along the movement path.

Meanwhile, in the photographing system 10 in FIG. 1, in a case where a certain camera robot 20ᵢ that is paid attention to is located in a photographing range which is being photographed by a camera 21ₖ of another camera robot 20ₖ, the camera robot 20ᵢ appears in an image being photographed by the other camera robot 20ₖ (with the camera 21ₖ) (i≠k).

When the camera robot 20ᵢ appears in an image being photographed by the other camera robot 20ₖ (a photographed image obtained through photographing by the camera robot 20ₖ), the sense of realism in the image being photographed by the other camera robot 20ₖ is significantly impaired.

In order to prevent the camera robot 20ᵢ from appearing in an image being photographed by the other camera robot 20ₖ, there is a method of causing the camera robots 20ᵢ and 20ₖ to share the positions of the camera robots and the position of a subject, and causing the camera robot 20ₖ to set the position of the camera robot 20ᵢ to a photographing prohibition position at which photographing is prohibited and to perform a zoom adjustment so as to avoid photographing the photographing prohibition position, for example.

However, in a case where the camera robot 20ₖ performs a zoom adjustment to avoid photographing the photographing prohibition position, a remarkable restriction may be imposed on the camera robot 20ₖ to photograph a subject. That is, in a case where the camera robot 20ₖ performs a zoom adjustment to avoid photographing the photographing prohibition position, the angle of view in an image being photographed by the camera robot 20ₖ is narrowed, so that, when the camera robot 20ₖ is located at a certain photographing position, the subject is not contained within an image being photographed by the camera robot 20ₖ.

Therefore, the camera robots 20₁ to 20₅ cooperatively conduct respective photographing actions to avoid obstructions of photographing such as appearing in an image being photographed by another one of the camera robots.

That is, the camera robot 20ᵢ transmits photographing information including information regarding a photographing range of the camera robot 20ᵢ, and receives photographing information including regarding a photographing range of the other camera robot 20ₖ. Accordingly, the respective camera robots 20₁ to 20₅ share photographing information with one another.

Here, exchange of photographing information among the camera robots 20₁ to 20₅ can be performed by what is called peer-to-peer, or can be performed via a server, etc., that serves as a control device for generally controlling the photographing system (FIG. 1).

The camera robot 20ᵢ controls a photographing action according to photographing information regarding the other camera robot 20ₖ. Accordingly, the camera robot 20ᵢ conducts the photographing action while inhibiting the camera robot 20ᵢ from obstructing photographing such that, for example, the camera robot 20ᵢ is inhibited from entering a photographing range of the other camera robot 20ₖ and appearing in an image being photographed by the other camera robot 20ₖ.

As a result of the above photographing action, a subject that is moving in a three-dimensional space can be photographed while the respective degrees of freedom of the photographing actions of the camera robots 20₁ to 20₅ are not remarkably restricted and while obstruction of photographing being performed by the other camera robots is inhibited.

<Outline of Photographing Action that does not Involve Obstruction of Photographing>

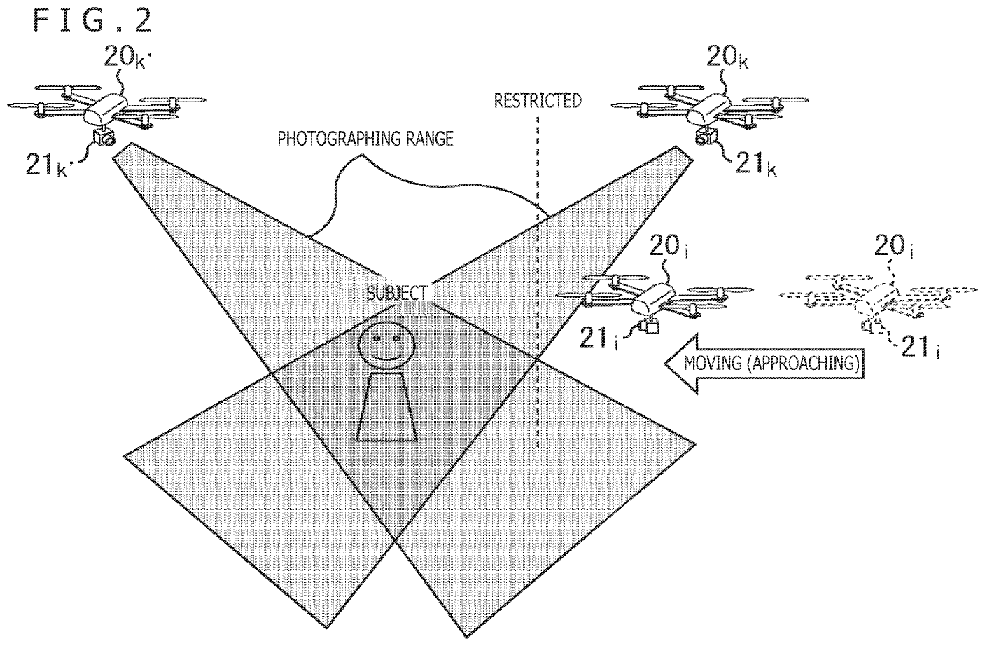

FIG. 2 is a diagram for explaining the outline of an example of a photographing action that does not involve obstruction of photographing.

In FIG. 2, three camera robots 20ᵢ, 20ₖ, and 20_{k′} perform photographing of the same subject.

The camera robot 20ᵢ receives photographing information regarding the other camera robots 20ₖ and 20_{k′}, as appropriate, and recognizes, on the basis of the photographing information, the respective photographing ranges of the other camera robots 20ₖ and 20_{k′} (i≠k≠k′). Here, the photographing range of the camera robot 20ₖ is expressed by a quadrangular pyramid (or a frustum that is a part of the quadrangular pyramid) a vertex of which is set at the photographing position of the camera robot 20ₖ (the position of the camera 21ₖ), for example. It is to be noted that a quadrangular pyramid has one vertex that is not in contact with the bottom surface, and four vertexes that are in contact with the bottom surface. In the present description, the term “main vertex” is used to describe only a vertex that is not in contact with the bottom surface. The photographing range of the camera robot 20ₖ is expressed by a quadrangular pyramid having a main vertex at the photographing position of the camera robot 20ₖ.

For example, when conducting a movement as a photographing action, the camera robot 20ᵢ moves while avoiding entering any of the photographing ranges of the other camera robots 20ₖ and 20_{k′}. In FIG. 2, the camera robot 20ᵢ is moving to approach the subject. Such movement which is the photographing action of the camera robot 20ᵢ is restricted by the photographing ranges of the other camera robots 20ₖ and 20_{k′}. That is, the camera robot 20ᵢ conducts the photographing action so as not to obstruct photographing being performed by the other camera robots 20ₖ and 20_{k′}.

Similar to the camera robot 20ᵢ, the camera robots 20ₖ and 20_{k′} also transmit and receive photographing information, and conduct respective photographing actions according to the photographing information.

Here, the camera robots 20₁ to 20₅ in FIG. 1 perform the similar processes. Therefore, the camera robot 20ᵢ conducts a photographing action according to the photographing information regarding the other camera robot (another camera robot relative to the camera robot 20ᵢ) 20ₖ while avoiding obstructing photographing being performed by the other camera robot 20ₖ, while the camera robot 20ₖ conducts a photographing action according to the photographing information regarding the other camera robot (another camera robot relative to the camera robot 20ₖ) 20ᵢ while avoiding obstructing photographing being performed by the other camera robot 20ᵢ. However, for simplicity of explanation, with respect to the camera robots 20ᵢ and 20ₖ, an explanation of a photographing action to be conducted by the camera robot 20ᵢ according to the photographing information regarding the other camera robot 20ₖ is given below, and an explanation of a photographing action to be conducted by the camera robot 20ₖ according to the photographing information regarding the other camera robot 20ᵢ is omitted, as appropriate.

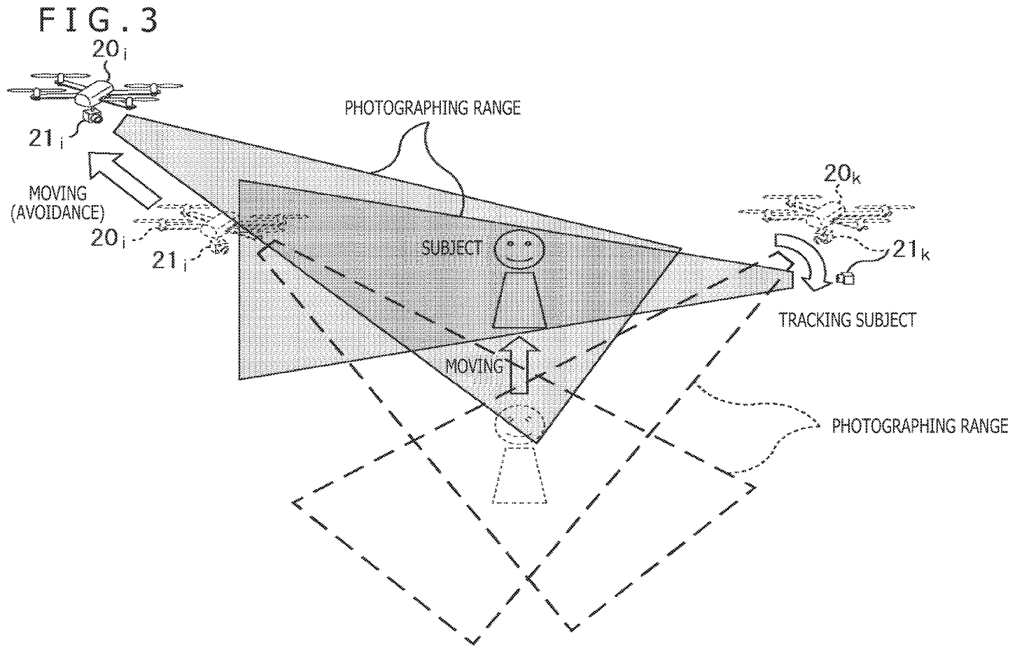

FIG. 3 is a diagram for explaining the outline of another example of a photographing action that does not involve obstruction of photographing.

In FIG. 3, two camera robots 20ᵢ and 20ₖ are performing photographing of the same subject.

As explained previously with reference to FIG. 2, the camera robot 20ᵢ receives photographing information regarding the other camera robot 20ₖ, as appropriate, and recognizes a photographing range of the other camera robot 20ₖ on the basis of the photographing information.

In FIG. 3, since the subject is moving, the camera robots 20ᵢ and 20ₖ each conduct a movement as a photographing action to track the moving subject.

The photographing ranges of the camera robots 20ᵢ and 20ₖ are moved according to movements of the camera robots 20ᵢ and 20ₖ, respectively.

When conducting a movement as a photographing action, the camera robot 20ᵢ moves while avoiding entering the photographing range of the other camera robot 20ₖ.

In FIG. 3, the photographing range of the camera robot 20ₖ is moving toward a direction to cause the camera robot 20ᵢ to enter the photographing range of the other camera robot 20ₖ. Therefore, the camera robot 20ᵢ conducts a movement as a photographing action to avoid entering the photographing range of the other camera robot 20ₖ.

It is to be noted that, under a condition in which the camera robot 20ᵢ is located in the photographing range of the camera robot 20ₖ and the camera robot 20ₖ is located in the photographing range of the camera robot 20ᵢ (hereinafter, also referred to as an obstruction contention condition), each of the camera robots 20ᵢ and 20ₖ can conduct an avoidance action to conduct a movement while avoiding entering the photographing range of the other camera robot. In this case, an obstruction contention condition may be established again as a result of the respective avoidance actions of the camera robots 20ᵢ and 20ₖ. Therefore, each of the camera robots 20ᵢ and 20ₖ repeats the avoidance action until the obstruction contention condition is canceled.

In addition, in the photographing system (FIG. 1), a priority order indicating whether an avoidance action is preferentially conducted by the camera robot 20ᵢ or is preferentially conducted by the camera robot 20ₖ, under the obstruction contention condition, may be preliminarily set. In this case, (only) one of the camera robots 20ᵢ and 20ₖ to which a higher priority for conducting an avoidance action has been given conducts the avoidance action.

Photographing information regarding the camera robot 20ₖ can include not only information regarding the photographing range of the camera robot 20ₖ but also information regarding a predicted photographing range which is predicted to become a next photographing range of the camera robot 20ₖ. The predicted photographing range of the camera robot 20ₖ can be predicted according to a photographing target of the (camera 21ₖ of the) camera robot 20ₖ, for example. A photographing target of the camera robot 20ₖ means a subject or content to be photographed by the camera robot 20ₖ. For example, in a case where the camera robot 20ₖ performs photographing of a soccer game, the content is the soccer game and the subject is a soccer ball being used in the soccer game, a soccer player participating in the soccer game, or the like.

For example, in a case where the camera robot 20ₖ performs photographing of a soccer player participating in a soccer game, the camera robot 20ₖ can set, as a predicted photographing range, a goal direction range in the vicinity of the photographing range because it is highly likely that the soccer player moves in a direction toward a goal in the soccer field, and then, the camera robot 20ₖ can transmit photographing information including information regarding the predicted photographing range.

In this case, the camera robot 20ᵢ can recognize, on the basis of the photographing information regarding the other camera robot 20ₖ, the photographing range and the predicted photographing range of the other camera robot 20ₖ, and can conduct an avoidance action (photographing action) not to enter the photographing range or the predicted photographing range. In this case, the camera robot 20ᵢ can be more strictly prevented from obstructing photographing being performed by the other camera robot 20ₖ (from appearing in an image being photographed by the other camera robot 20ₖ), and further, the obstruction contention condition can be canceled in an early stage.

### <Obstruction Cost>

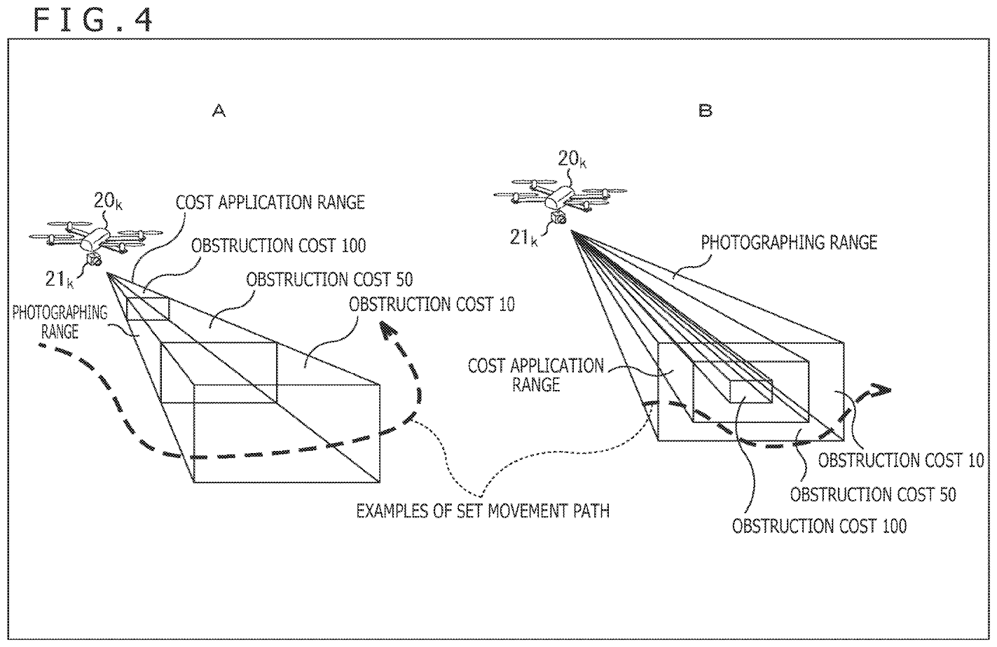

FIG. 4 depicts diagrams for explaining the outline of obstruction cost setting.

The camera robot 20ₖ can set, for a photographing range or predicted photographing range of the camera robot 20ₖ, one or more obstruction costs each representing the likelihood that the other camera robot (another camera robot relative to the camera robot 20ₖ) 20ᵢ obstructs the photographing being performed by the camera robot 20ₖ.

Here, regarding an obstruction cost, it is assumed that a larger value indicates a higher likelihood of obstructing photographing, for example.

A of FIG. 4 depicts an example of setting obstruction costs according to a distance (photographing distance) from the photographing position of the camera robot 20ₖ.

In A of FIG. 4, a quadrangular pyramid that represents a photographing range is sectioned into three cost application ranges according to a photographing distance. That is, the quadrangular pyramid that represents the photographing range is sectioned, by planes that are perpendicular to the optical axis of the camera 21ₖ, into a near-side cost application range, a middle cost application range, and a far-side cost application range (when viewed from the camera 21ₖ (photographing position)).

An obstruction cost of 100 which is a large value, an obstruction cost of 50 which is a medium value, and an obstruction cost of 10 which is a small value, are set to the near-side cost application range, the middle cost application range, and the far-side cost application range, respectively.

Here, when the camera robot 20ᵢ is located at a position closer to the camera 21ₖ of the camera robot 20ₖ, the camera robot 10ᵢ in a larger size appears in an image (photographed image obtained through photographing by the camera 21ₖ of the camera robot 20ₖ) being photographed by the camera robot 20ₖ. Thus, the likelihood that the camera robot 20ᵢ obstructs photographing being performed by the camera robot 20ₖ is higher. Therefore, in A of FIG. 4, a larger obstruction cost value is set for a cost application range closer to the camera 21ₖ of the camera robot 20ₖ.

B of FIG. 4 depicts an example of setting costs according to a distance from an attention region in an image being photographed by the camera robot 20ₖ.

Here, an attention region of a photographed image refers to a region, in the photographed image, where a subject (e.g., a subject such as a soccer player or a soccer ball in a soccer game to which a user who is viewing the soccer game pays attention) appears. The subject is usually photographed so as to appear in the center of the photographed image. In this case, in an image being photographed by the camera robot 20ₖ, a distance from an attention region corresponds to an angle (angle of view) formed relative to the optical axis of the (camera 21ₖ of the) camera robot 20ₖ. Thus, setting costs according to a distance from an attention region can be considered to set costs according to an angle of view.

In B of FIG. 4, a quadrangular pyramid that represents a photographing range is sectioned into three cost application ranges on the basis of the angle of view. That is, the quadrangular pyramid that represents the photographing range is sectioned into a central cost application range close to the optical axis of the camera 21ₖ, a middle cost application range surrounding the central cost application range, and an outer cost application range surrounding the middle cost application range.

An obstruction cost of 100 which is a large value, an obstruction cost of 50 which is a medium value, and an obstruction cost of 10 which is a small value, are set to the central cost application range, the middle cost application range, and the outer cost application range, respectively.

Here, when the camera robot 20ᵢ appears in a position closer to the center of the image being photographed by the camera robot 20ₖ, the likelihood that the camera robot 20ᵢ obstructs photographing being performed by the camera robot 20ₖ is higher. Therefore, in B of FIG. 4, a larger obstruction cost value is set for a cost application range closer to the optical axis of the camera 21ₖ.

As illustrated in FIG. 4, an obstruction cost (and a cost application range) can be flexibly set.

The camera robot 20ₖ sets one or more obstruction costs for the photographing range and the predicted photographing range of the camera robot 20ₖ, and sets, within the photographing range and the predicted photographing range, cost application ranges to which the respective obstruction costs are applied. Then, the camera robot 20ₖ generates photographing information including the obstruction costs and including range information indicating the cost application ranges, and transmits the photographing information to the camera robot 20ᵢ.

The camera robot 20ᵢ recognizes the obstruction costs at respective positions in the three-dimensional space according to the photographing information regarding the camera robot 20ₖ, and plans a photographing action of the camera robot 20ᵢ according to the obstruction costs. That is, the camera robot 20ᵢ searches for a path which extends from the current position and on which the cumulative value of the obstruction costs becomes a global minimum or a local minimum, for example, and sets the path as a movement path of the camera robot 20ᵢ. Subsequently, the camera robot 20ᵢ conducts a movement, as a photographing action, along the movement path set according to the obstruction costs.

Here, in the search for the path, a graph search algorithm such as an A*(A-star) or any other path search algorithm can be adopted, for example.

In the present technique, since obstruction costs can be flexibly set in the aforementioned manner, a situation where the camera robot 20ᵢ appears in an image being photographed by the camera robot 20ₖ may occur although the likelihood of this situation is low. However, the situation where the camera robot 20ᵢ appears in an image being photographed by the camera robot 20ₖ is allowed, so that a flexible path can be set as a movement path of the camera robot 20ᵢ.

It is to be noted that, even when the camera robot 20ᵢ appears in an image being photographed by the camera robot 20ₖ, the appearance is less noticeable in a case where the image being photographed by the camera robot 20ₖ is a still image than a case where the image is a video. Thus, an obstruction cost of a small value can be set.

Here, regarding an obstruction cost in a three-dimensional space outside the cost application range of the camera robot 20ₖ, it can be interpreted that no obstruction cost is set, or it can be interpreted that an obstruction cost having a value of 0 is set.

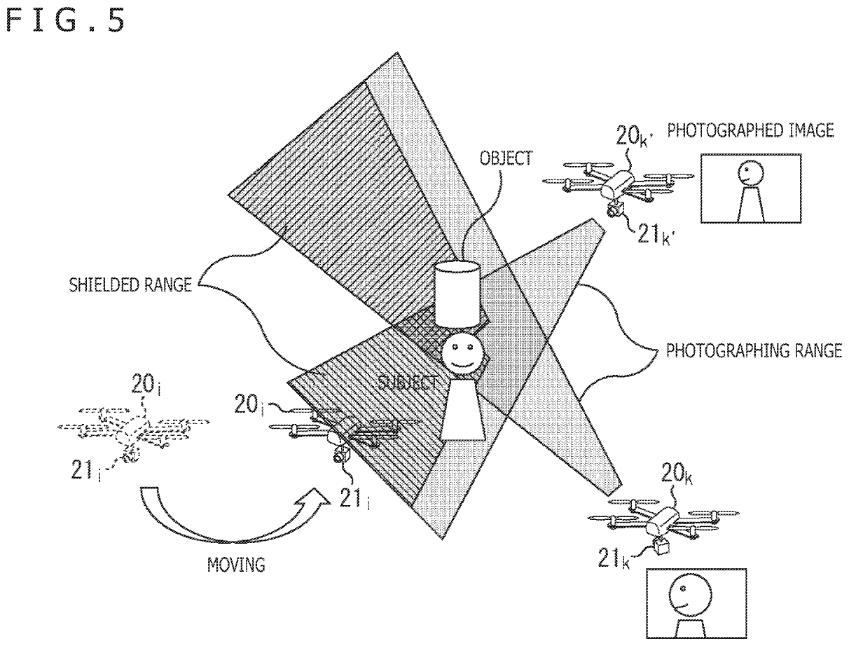

FIG. 5 is a diagram for explaining a shielded range.

Even within the photographing range and the predicted photographing range of the camera robot 20ₖ, a range that is a dead angle to the photographing position of the (camera 21ₖ of the) camera robot 20ₖ may exist, in some cases. A shielded range where light from the photographing position of the camera robot 20ₖ (the position of the camera 21ₖ) is shielded by a subject or an object located in the photographing range of the camera robot 20ₖ is a dead angle to the photographing position of the camera robot 20ₖ, and thus, the shielded range is not viewable from the photographing position of the camera robot 20ₖ. Therefore, even when the camera robot 20ᵢ enters the shielded range of the camera robot 20ₖ, the camera robot 20ᵢ does not appear in an image being photographed by the camera robot 20ₖ.

Thus, the camera robot 20ₖ can set obstruction costs according to the shielded range. For example, the camera robot 20ₖ can set, for the shielded range, an obstruction cost of 0 or an obstruction cost the value of which is small.

In this case, the camera robot 20ᵢ can move in the shielded range of the camera robot 20ₖ or set a photographing position in the shielded range.

It is to be noted that the shielded range may be calculated, at the camera robot 20ₖ, from information regarding a distance obtained by use of a stereo camera or a ranging sensor such as a ToF sensor or a LIDAR (Light Detection and Ranging), for example.

<Configuration Example of Camera Robot 20ᵢ>

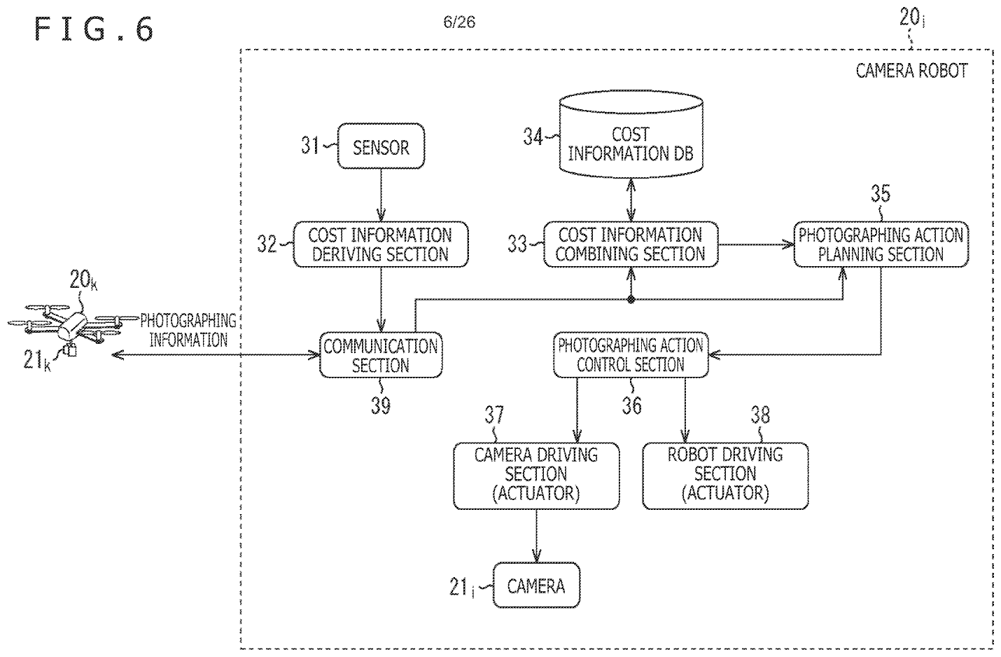

FIG. 6 is a block diagram depicting a configuration example of the camera robot 20ᵢ in FIG. 1.

As explained previously with reference to FIG. 1, the camera robot 20ᵢ includes the camera 21ᵢ. The camera robot 20ᵢ further includes a sensor 31, a cost information deriving section 32, a cost information combining section 33, a cost information DB (database) 34, a photographing action planning section 35, a photographing action control section 36, a camera driving section 37, a robot driving section 38, and a communication section 39.

The sensor 31 includes a sensor that detects the position of the camera robot 20ᵢ through a GPS (Global Positioning System), or a sensor that detects the attitude of the camera robot 20ᵢ and the attitude of the camera 21ᵢ, for example. The sensor 31 further includes a stereo camera, a ranging sensor such as a ToF sensor, and other sensors, if needed. The sensor 31 performs sensing to detect the position of the camera robot 20ᵢ, the attitude of the camera robot 20ᵢ, and the attitude of the camera 21ᵢ, etc., on a regular basis, and supplies sensing information obtained by the sensing to the cost information deriving section 32.

The cost information deriving section 32 detects (calculates) a photographing range of the camera robot 20ᵢ by using the sensing information supplied from the sensor 31, and sets (predicts) a predicted photographing range with respect to the photographing range, according to a photographing target of the camera robot 20ᵢ or the like.

Further, the cost information deriving section 32 sets one or more obstruction costs in the photographing range and the predicted photographing range of the camera robot 20ᵢ, and generates cost information that includes the obstruction costs and includes range information indicating cost application ranges to which the respective obstruction costs are applied in the photographing range and the predicted photographing range.

In addition, the cost information deriving section 32 recognizes, on the basis of the sensing information supplied from the sensor 31, the position (current position) (e.g., absolute three-dimensional coordinates) of the camera robot 20ᵢ, and sets the position of the camera robot 20ᵢ as a photographing prohibition position, if needed.

Subsequently, the cost information deriving section 32 generates cost information, and further generates, if needed, photographing information including the photographing prohibition position, and supplies the generated information to the communication section 39.

Consequently, the photographing information regarding the camera robot 20ᵢ includes the cost information, and, if needed, further includes a photographing prohibition position.

The cost information includes range information indicating cost application ranges, and obstruction costs that are applied to the cost application ranges indicated by the range information. Here, an obstruction cost is set throughout at least the photographing range, or throughout the photographing range and the predicted photographing range. Therefore, the cost information includes information regarding the whole of the photographing range or information regarding the whole of the photographing range and the predicted photographing range.

As the obstruction costs, one value that represents an obstruction cost which is applied to the whole of the cost application range, multiple values that represent respective obstruction costs of grid-like discrete positions in the cost application range, a function that expresses respective obstruction costs of positions in the cost application range, or the like, can be adopted. As the function expressing the obstruction costs, a Gaussian function expressed by the formula “Aexp(−Bx²)” or the like can be adopted, for example.

In the formula “Aexp(−Bx²),” A and B each represent a constant number, exp represents an exponential function, and x represents a variable corresponding to a position in the cost application range. As the argument x, an angle θ formed between the optical axis of the camera 21ᵢ of the camera robot 20ᵢ and a line segment connecting the main vertex of the quadrangular pyramid representing the photographing range to a position in the cost application range, or a difference F-Z between a focal distance F of the camera 21ᵢ and a distance Z to a position in the cost application range, can be adopted, for example.

For example, a quadrangular pyramid having a main vertex at the photographing position of the (camera 21ᵢ of the) camera robot 20ᵢ, a frustum that is a part of the quadrangular pyramid, or any other three-dimensional shape can be adopted as the cost application range. For example, the positions of vertexes of a three-dimensional shape adopted as the cost application range can be adopted as the range information.

As the positions of vertexes adopted as the range information, the absolute positions of the vertexes of the three-dimensional shape, the absolute position indicating a photographing position, relative positions of the respective vertexes of the three-dimensional shape with respect to the photographing position, and the like, can be adopted.

It is to be noted that, in a case where one cost application range is a photographing range, not only the aforementioned information but also an absolute position indicating the photographing position, a photographing distance limit (a distance at which, even when another camera robot appears in a photographed image, the size of the camera robot in the photographed image is so small that the camera robot can be neglected), the horizontal angle of view, and the aspect ratio (or the vertical angle of view) of the camera 21ᵢ can be adopted as the range information indicating the cost application range as the photographing range.

Photographing information regarding the other camera robots 20ₖ, that is, the camera robots 20ₖ except the camera robot 20ᵢ is supplied from the communication section 39 to the cost information combining section 33.

The cost information combining section 33 supplies, to the cost information DB 34, the cost information included in the photographing information regarding the respective camera robots 20ₖ supplied from the communication section 39, and the cost information DB 34 stores the cost information. Moreover, the cost information combining section 33 combines cost information regarding the respective camera robots 20ₖ stored in the cost information DB 34, and supplies combined cost information obtained by the combining to the photographing action planning section 35.

To combine cost information regarding two camera robots 20ₖ and 20_{k′}, for example, obstruction costs included in cost information regarding the camera robot 20ₖ and obstruction costs included in cost information regarding the camera robot 20ₖ are combined together, and thus, a combined cost is generated. Therefore, combined cost information includes the combined cost.

The cost information DB 34 temporarily stores the cost information supplied from the cost information combining section 33.

The combined cost information is supplied from the cost information combining section 33 to the photographing action planning section 35, and further, photographing information regarding the other camera robots 20ₖ (camera robots 20ₖ except the camera robot 20ᵢ) is supplied from the communication section 39 to the photographing action planning section 35.

The photographing action planning section 35 makes a plan for a photographing action (photographing action plan), according to the combined cost information supplied from the cost information combining section 33 and the photographing prohibition position included in the photographing information regarding the other camera robot 20ₖ supplied from the communication section 39.

That is, the photographing action planning section 35 sets a photographing position that is optimum (an optimum photographing position) through searching, and corrects the optimum photographing position, if needed, according to the combined cost information. Further, the photographing action planning section 35 makes a photographing action plan for photographing a subject from the optimum photographing position. The photographing action plan for photographing a subject from the optimum photographing position includes searching for a path which extends from the current position to the optimum photographing position and on which the cumulative value of combined costs (along the path) is globally or locally minimized according to the combined cost information, setting the camera angle (attitude) or zoom magnification of the camera 21ᵢ, performing setting (photographing-prohibition-position photographing inhibition setting) to inhibit photographing of the photographing prohibition position included in the photographing information regarding the camera robot 20ₖ (to inhibit the photographing prohibition position from being included in the photographing range of the camera robot 20ᵢ), and the like.

The photographing action planning section 35 supplies the photographing action plan to the photographing action control section 36.

The photographing action control section 36 controls a photographing action of the camera robot 20ᵢ according to the photographing action plan supplied from the photographing action planning section 35. As explained previously, the photographing action plan is made according to the photographing information regarding the other camera robot 20ₖ. Accordingly, the photographing action control section 36 which controls a photographing action according to the photographing action plan can be interpreted to control a photographing action according to the photographing information regarding the other camera robot 20ₖ.

Controlling a photographing action involves controlling the camera driving section 37 and the robot driving section 38 to control setting of the camera angle or zoom magnification of the camera 21ᵢ and a movement of the camera robot 20ᵢ.

The camera driving section 37 includes a support member that supports the camera 21ᵢ on the camera robot 20ᵢ, and an actuator that drives a zoom ring, a focus ring, etc., of the camera 21ᵢ. Under control of the photographing action control section 36, the camera driving section 37 drives the support member that supports the camera 21₁ on the camera robot 20ᵢ and drives the zoom ring, the focus ring, etc., of the camera 21ᵢ. Accordingly, a camera control for controlling the camera angle, the zoom magnification, the focus, etc., of the camera 21ᵢ is performed.

The robot driving section 38 includes an actuator that moves the camera robot 20ᵢ that is, an actuator that drives a rotor or the like of a drone serving as the camera robot 20ᵢ, for example. Under control of the photographing action control section 36, the robot driving section 38 drives the rotor of the drone serving as the camera robot 20ᵢ. Accordingly, the drone serving as the camera robot 20ᵢ moves along the path set by the photographing action plan.

The communication section 39 wirelessly exchanges necessary information with the other camera robot 20ₖ (in a direct or indirect manner). That is, for example, the communication section 39 receives photographing information transmitted from the other camera robot 20ₖ, and supplies the photographing information to the cost information combining section 33 and the photographing action planning section 35. Also, the communication section 39 transmits photographing information regarding the camera robot 20ᵢ supplied from the cost information deriving section 32 (to the other camera robot 20ₖ).

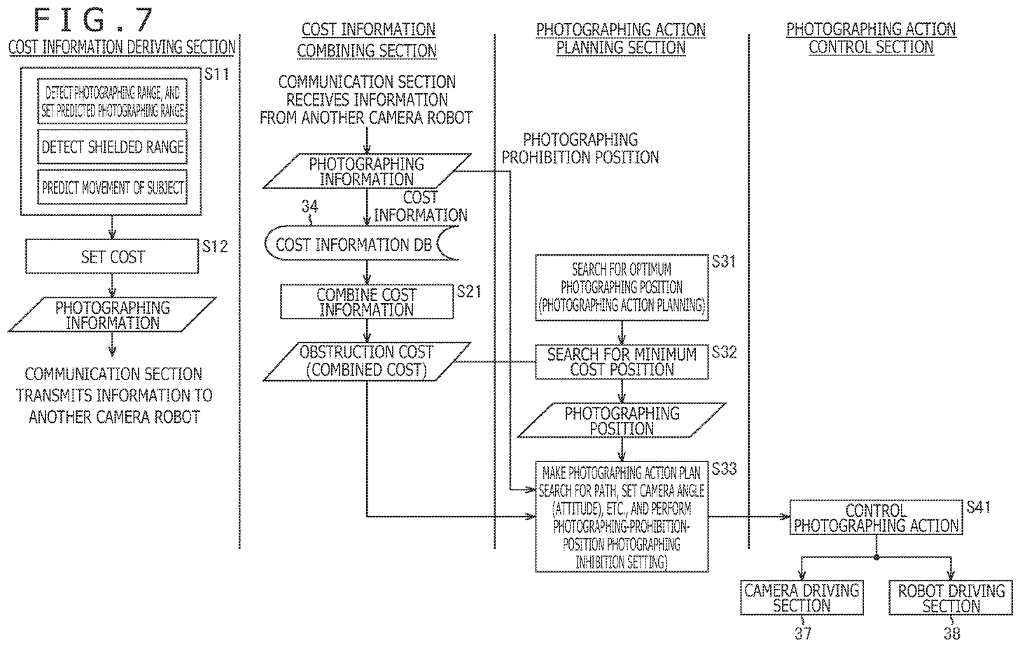

FIG. 7 is a diagram for explaining the outline of processes at the camera robot 20ᵢ in FIG. 6.

In step S11, the cost information deriving section 32 detects a photographing range of the camera robot 20ᵢ by using sensing information supplied from the sensor 31, and sets (predicts) a predicted photographing range with respect to the photographing range according to a photographing target or the like for the camera robot 20ᵢ.

Further, in step S11, the cost information deriving section 32 detects a shielded range which is a dead angle to the photographing position of the camera robot 20ₖ, by using sensing information supplied from the sensor 31.

Moreover, in step S11, the cost information deriving section 32 conducts a subject prediction to predict a movement of the subject being photographed by the camera 21₁.

Then, the process proceeds from step S11 to step S12 at which the cost information deriving section 32 sets, in the photographing range and the predicted photographing range of the camera robot 20ᵢ, one or more obstruction costs according to the shielded range and the prediction result of the subject prediction, etc. Further, the cost information deriving section 32 generates cost information that includes the obstruction costs and includes range information indicating cost application ranges to which the respective obstruction costs are applied in the photographing range and the predicted photographing range.

In addition, the cost information deriving section 32 recognizes, on the basis of the sensing information supplied from the sensor 31, the position of the camera robot 20ᵢ, and sets, if needed, the position of the camera robot 20ᵢ as a photographing prohibition position.

Subsequently, the cost information deriving section 32 generates photographing information including the cost information and the photographing prohibition position, if needed, and supplies the photographing information to the communication section 39. Then, the photographing information regarding the camera robot 20ᵢ is transmitted from the communication section 39 to the other camera robots 20ₖ, that is, the camera robots 20ₖ except the camera robot 20ᵢ, such that the photographing information is shared by the camera robots 20ₖ.

In addition, the communication section 39 receives photographing information transmitted from the other camera robots 20ₖ, that is, the camera robots 20ₖ except the camera robot 20ᵢ, and supplies the photographing information to the cost information combining section 33 and the photographing action planning section 35. The cost information combining section 33 supplies the photographing information regarding the camera robots 20ₖ supplied from the communication section 39 to the cost information DB 34, and the cost information DB 34 stores the photographing information.

Then, in step S21, the cost information combining section 33 combines the cost information regarding the respective camera robots 20ₖ stored in the cost information DB 34, and supplies combined cost information including a combined cost obtained by the combining, to the photographing action planning section 35.

In step S31, the photographing action planning section 35 conducts, as a part of the photographing action plan, an optimum photographing position search of searching (setting) an optimum photographing position according to a photographed image or the like being photographed by the camera 21ᵢ. Then, the process proceeds to step S32.

In step S32, the photographing action planning section 35 corrects the optimum photographing position according to the combined cost information. That is, the photographing action planning section 35 conducts a minimum cost position search of searching a position at which the combined cost is minimized in a peripheral range expanded around the optimum photographing position, and sets, as a corrected optimum photographing position, the position (minimum cost position) at which the combined cost becomes minimum in the peripheral range of the optimum photographing position.

Then, the process proceeds from step S32 to step S33 at which the photographing action planning section 35 makes a photographing action plan for photographing a subject from the (corrected) optimum photographing position. That is, the photographing action planning section 35 searches for a path which extends from the current position to the optimum photographing position and on which the cumulative value of combined costs becomes a global minimum or local minimum, according to the combined cost information, and sets, as a movement path of the camera robot 20ᵢ, the path obtained by the search. The photographing action planning section 35 performs setting for a camera control of the camera angle (attitude) and the zoom magnification, etc., of the camera 21ᵢ at a time of photographing a subject from the (corrected) optimum photographing position. Further, the photographing action planning section 35 performs photographing-prohibition-position photographing inhibition setting of inhibiting photographing of photographing prohibition positions included in the photographing information regarding the other camera robots 20ₖ (inhibiting the photographing prohibition positions from being included in the photographing range of the camera robot 20ᵢ).

According to the photographing action plan made by the photographing action planning section 35, a search for a path and camera control setting, etc., are conducted so as to inhibit the camera 21ᵢ from photographing the photographing prohibition position through the photographing-prohibition-position photographing inhibition setting.

The photographing action planning section 35 supplies the photographing action plan to the photographing action control section 36.

In step S41, the photographing action control section 36 controls the camera driving section 37 and the robot driving section 38 according to the photographing action plan supplied from the photographing action planning section 35, thereby controlling a photographing action of the camera robot 20ᵢ.

Accordingly, the camera robot 20ᵢ conducts a photographing action such as a movement so as to inhibit obstruction of photographing being performed by the other camera robots 20ₖ and so as to inhibit photographing of any of positions (the current positions of the other camera robots 20ₖ) set as photographing prohibition positions by the other camera robots 20ₖ.

In the manner explained so far, the camera robot 20ᵢ transmits photographing information including information regarding a photographing range being photographed by the camera 21ᵢ, and receives photographing information including information regarding the photographing ranges of the other camera robots 20ₖ. Further, the camera robot 20ᵢ controls a photographing action for performing photographing by means of the camera 21ᵢ according to the photographing information regarding the other camera robots 20ₖ. Consequently, in the photographing system in FIG. 1, the multiple (five) camera robots 20₁ to 20₅ can be inhibited from obstructing each other's photographing. That is, for example, the camera robot 20ᵢ can be inhibited from appearing in any of images being photographed by the other camera robots 20ₖ.

<Specific Example of Processes at Camera Robot 20ᵢ>

Hereinafter, a specific example of processes at the camera robot 20ᵢ will be explained by using a case where the photographing system in FIG. 1 is applied to an automatic aerial photographing system that performs aerial photographing of a soccer game.

In the photographing system that is an automatic aerial photographing system, the camera robot 20ᵢ is assumed to be able to freely fly in (over) the soccer field. Furthermore, each of the camera robots 20₁ to 20₅ is assigned as any one of a bird's-eye-view camera robot, a ball-tracking camera robot, or a player-tracking camera robot.

Here, the bird's-eye-view camera robot flies at a height that is an altitude of around 10 m, and photographs a wide range of the soccer field mainly centered on a player who is having a soccer ball from a bird's-eye view. The bird's-eye-view camera robot conducts only a parallel movement at a fixed height position. Also, two camera robots are assigned as the bird's-eye-view camera robots. Two camera robots serving as the bird's-eye-view camera robots each photograph the soccer field from a bird's-eye view while moving at the same height position, so that each of the two camera robots does not appear in an image being photographed by the other camera robot.

The ball-tracking camera robot tracks a soccer ball while flying at a height of around 2 m or lower from the land, which is nearly as high as the human eye position. The ball-tracking camera robot photographs a narrow range mainly centered on the soccer ball. The ball-tracking camera robot conducts various photographing actions such as omni-directionally moving, upwardly tilting a camera provided to the ball-tracking camera robot in order to track and photograph the soccer ball in the air, and panning a camera provided to the ball-tracking camera robot in a horizontal direction in response to passing a long ball, etc. One camera robot is assigned as the ball-tracking camera robot.

Like the ball-tracking camera robot, the player-tracking camera robot tracks a soccer player while flying at a height of around 2 m or lower from the land, which is nearly as high as the human eye position. The player-tracking camera robot omni-directionally moves and tracks and photographs a soccer player who is the center of a play according to the game situation. In addition, the player-tracking camera robot performs photographing while switching a soccer player to be tracked, according to a phase change such as passing a ball or an offense-defense change. Two camera robots are assigned as the player-tracking camera robots.

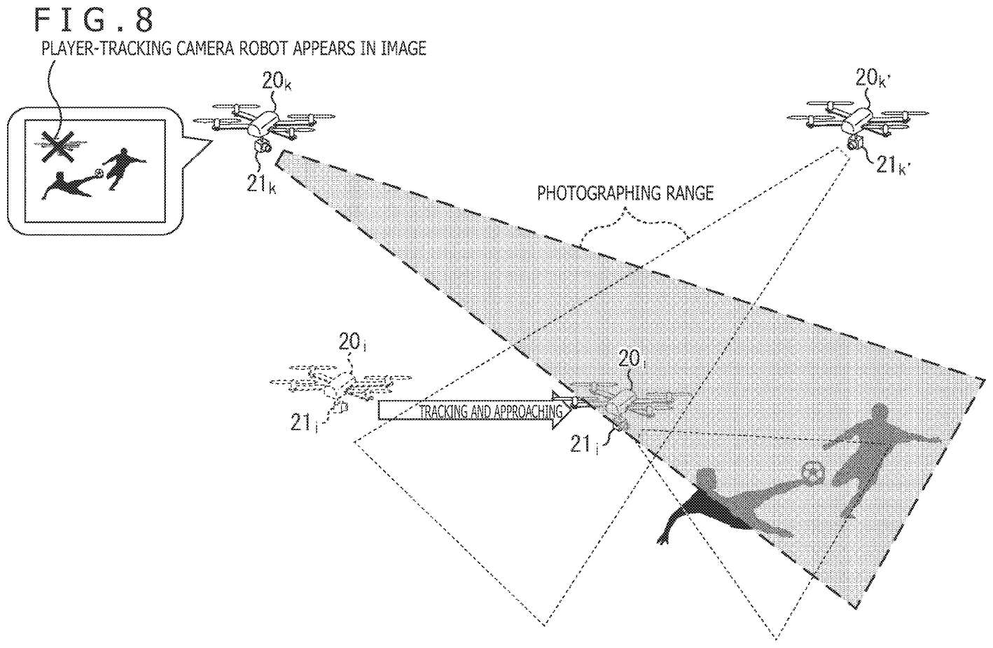

FIG. 8 is a diagram for explaining an example of a first photographing condition in which the camera robot 20ᵢ obstructs photographing being performed by the other camera robot 20ₖ.

In FIG. 8, the camera robot 20ᵢ serving as a player-tracking camera robot (or a ball-tracking camera robot) tracks a soccer player (or a soccer ball), and approaches the soccer player. As a result, the camera robot 20ᵢ enters each of the photographing ranges of the camera robots 20ₖ and 20ₖ, serving as bird's-eye-view camera robots. Accordingly, the camera robot 20ᵢ appears in each of images being photographed by the respective camera robots 20ₖ and 20ₖ, and thus, obstructs photographing being performed by the respective camera robots 20ₖ and 20_{k′}.

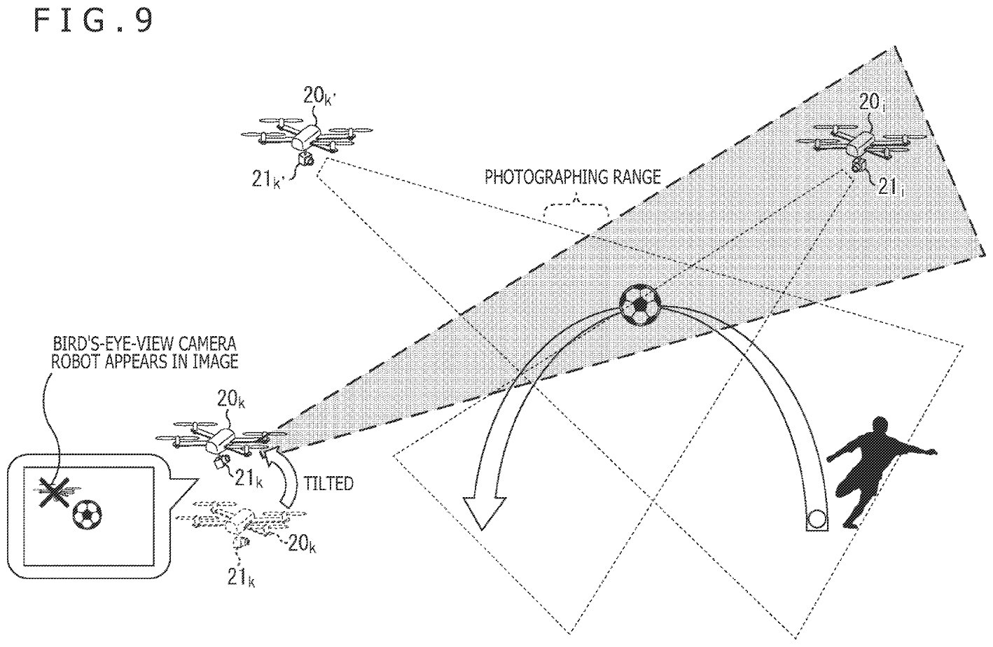

FIG. 9 is a diagram for explaining an example of a second photographing condition in which the camera robot 20ᵢ obstructs photographing being performed by the other camera robot 20ₖ.

In FIG. 9, the camera robot 20ₖ serving as a ball-tracking camera robot tracks a soccer ball, and upwardly tilts the camera 21ₖ. As a result, the camera robot 20ᵢ serving as a bird's-eye-view camera robot enters the photographing range of the camera robot 20ₖ. Accordingly, the camera robot 20ᵢ appears in an image being photographed by the camera robot 20ₖ, and thus, obstructs photographing being performed by the camera robot 20ₖ.

It is to be noted that, in FIG. 9, when the camera robot 20ₖ serving as a ball-tracking camera robot tracks the soccer ball and upwardly tilts the camera 21ₖ, the camera robot 20ₖ, serving as a bird's-eye-view camera robot is outside the photographing range of the camera robot 20ₖ, and thus, does not obstruct photographing being performed by the camera robot 20ₖ.

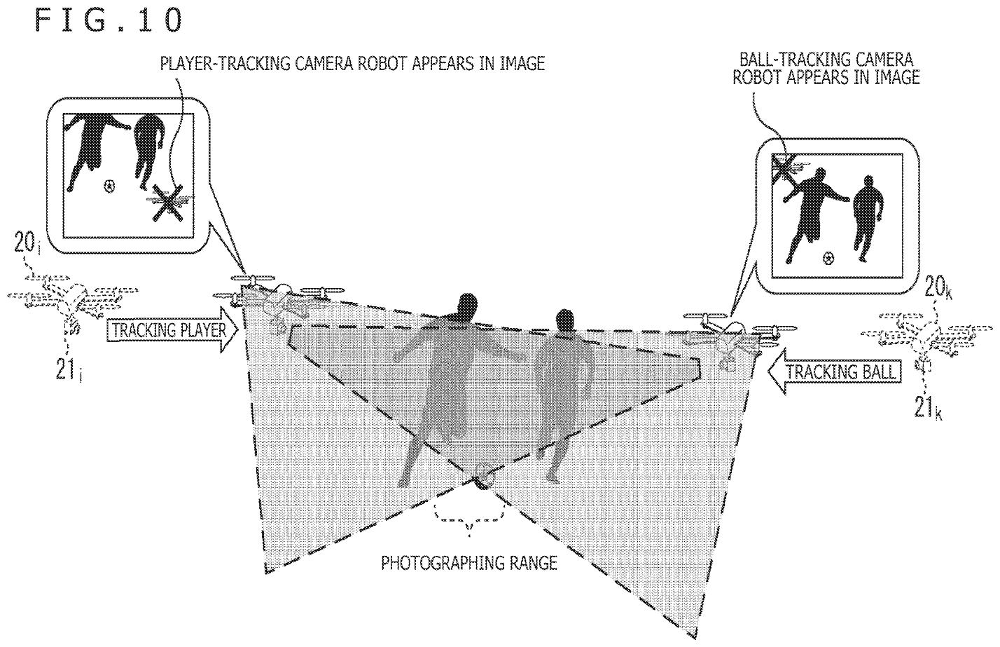

FIG. 10 is a diagram for explaining an example of a third photographing condition in which the camera robot 20ᵢ obstructs photographing being performed by the other camera robot 20ₖ.

In FIG. 10, the camera robot 20ᵢ serving as a ball-tracking camera robot is tracking a soccer ball while the camera robot 20ₖ serving as a player-tracking camera robot is tracking a soccer player. As a result, the camera robot 20ᵢ enters the photographing range of the camera robot 20ₖ. Accordingly, the camera robot 20ᵢ appears in an image being photographed by the camera robot 20ₖ, and thus, obstructs photographing being performed by the camera robot 20ₖ.

It is to be noted that, in FIG. 10, the camera robot 20ᵢ and the camera robot 20ₖ face each other, the camera robot 20ᵢ enters the photographing range of the camera robot 20ₖ, and further, the camera robot 20ₖ enters the photographing range of the camera robot 20ᵢ. Therefore, the camera robot 20ₖ appears in an image being photographed by the camera robot 20ᵢ, and thus, obstructs photographing being performed by the camera robot 20ᵢ.

Thus, in FIG. 10, the camera robots 20ᵢ and 20ₖ obstruct each other's photographing.

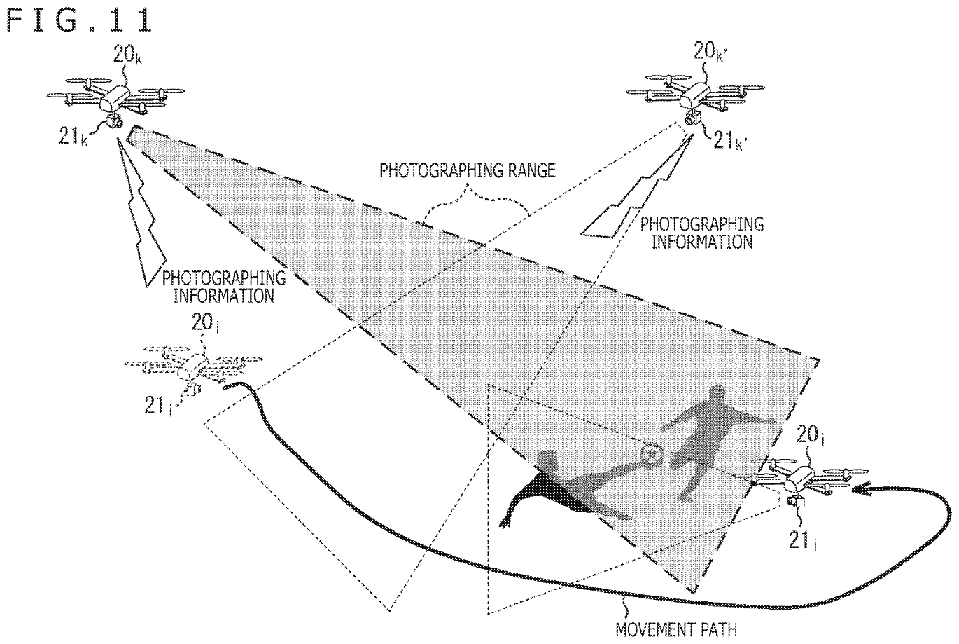

FIG. 11 is a diagram for explaining an example of a photographing action to inhibit the camera robot 20ᵢ from appearing in an image being photographed by the camera robot 20ₖ under the first photographing condition in FIG. 8.

In FIG. 11, the camera robot 20ᵢ serving as a player-tracking camera robot and the camera robots 20ₖ and 20ₖ, serving as bird's-eye-view camera robots each transmit photographing information regarding the camera robot itself.

The camera robot 20ᵢ receives photographing information regarding the other camera robots 20ₖ and 20ₖ, except the camera robot 20ᵢ, and generates combined cost information by combining cost information included in the photographing information regarding the respective camera robots 20ₖ and 20ₖ. Subsequently, the camera robot 20ᵢ conducts a photographing action according to the combined cost information. That is, the camera robot 20ᵢ makes a photographing action plan according to the combined cost information, and conducts a movement or the like as a photographing action according to the photographing action plan.

In the manner explained so far, a photographing action is conducted by the camera robot 20ᵢ according to the combined cost information. Thus, the camera robot 20ᵢ moves along a movement path to avoid positions in the three-dimensional space for which large obstruction costs have been set by the camera robots 20ₖ and 20_{k′}. Consequently, the camera robot 20ᵢ can be inhibited from appearing in an image being photographed by the camera robot 20ₖ (and an image being photographed by the camera robot 20_{k′}).

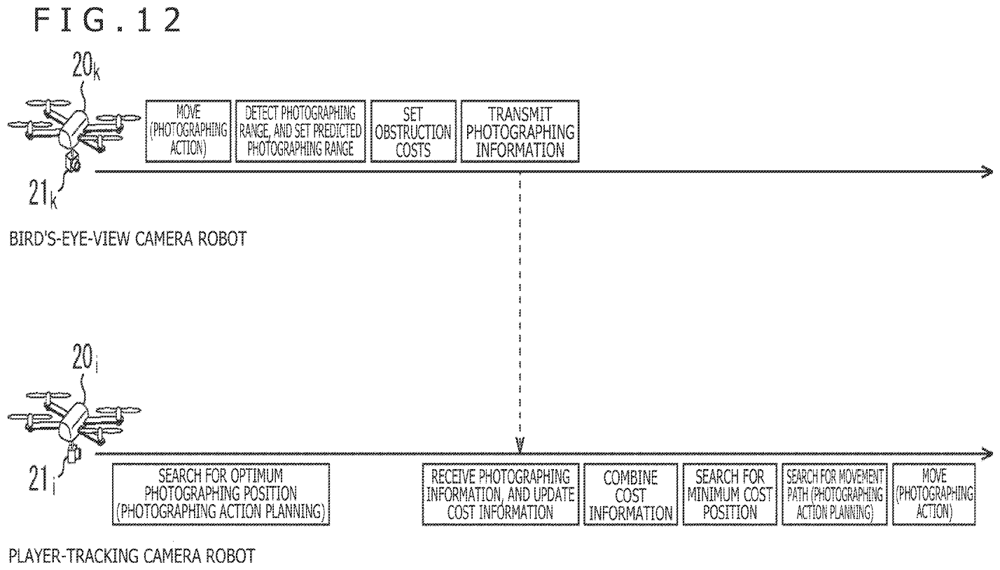

FIG. 12 is a diagram for explaining an example of processes at the camera robots 20ᵢ and 20ₖ in a case where a photographing action to inhibit the camera robot 20ᵢ from appearing in an image being photographed by the camera robot 20ₖ is conducted under the first photographing condition in FIG. 8.

The camera robot 20ₖ serving as a bird's-eye-view camera robot conducts a movement as a photographing action according to the photographing action plan, and then detects a photographing range and sets a predicted photographing range at a position (photographing position) reached after the movement.

Moreover, the camera robot 20ₖ sets one or more obstruction costs in the photographing range and the predicted photographing range, and generates cost information that includes the obstruction costs and includes range information indicating cost application ranges to which the obstruction costs are applied in the photographing range and the predicted photographing range.

Subsequently, the camera robot 20ₖ generates photographing information including the cost information, and transmits the photographing information.

Meanwhile, the camera robot 20ᵢ serving as a player-tracking camera robot conducts, as a photographing action plan, an optimum photographing position search of setting an optimum photographing position for tracking a player. Further, the camera robot 20ᵢ receives photographing information regarding camera robots including the camera robot 20ₖ but excluding the camera robot 20ᵢ, and updates cost information regarding the camera robots including the camera robot 20ₖ but excluding the camera robot 20ᵢ stored in the cost information DB 34, according to cost information included in the photographing information.

Thereafter, the camera robot 20ᵢ generates combined cost information by combining the cost information regarding the respective camera robots excluding the camera robot 20ᵢ stored in the cost information DB 34.

By using the combined cost information, the camera robot 20ᵢ conducts a minimum cost position search of searching for a position at which the combined cost is minimized in a peripheral range of the optimum photographing position set by the optimum photographing position search. Then, the camera robot 20ᵢ corrects the optimum photographing position to the minimum cost position at which the combined cost is minimized in the peripheral range of the optimum photographing position. That is, the camera robot 20ᵢ sets (resets) the optimum photographing position to the minimum cost position.

Furthermore, by using the combined cost information, the camera robot 20ᵢ conducts, as a photographing action plan, a search for a path which extends from the current position to the optimum photographing position and on which the cumulative value of combined costs becomes a global minimum or local minimum, and sets, as a movement path of the camera robot 20ᵢ, the path obtained by the search.

Subsequently, the camera robot 20ᵢ conducts, as a photographing action, a movement along the movement path set by the photographing action plan.

It is to be noted that the photographing action plan includes not only setting a movement path of the camera robot 20ᵢ but also setting a camera control, and a camera control is performed as a photographing action according to the setting.

However, an explanation of setting a camera control in the photographing action plan and an explanation of a camera control as a photographing action will be omitted from the following explanation, as appropriate.

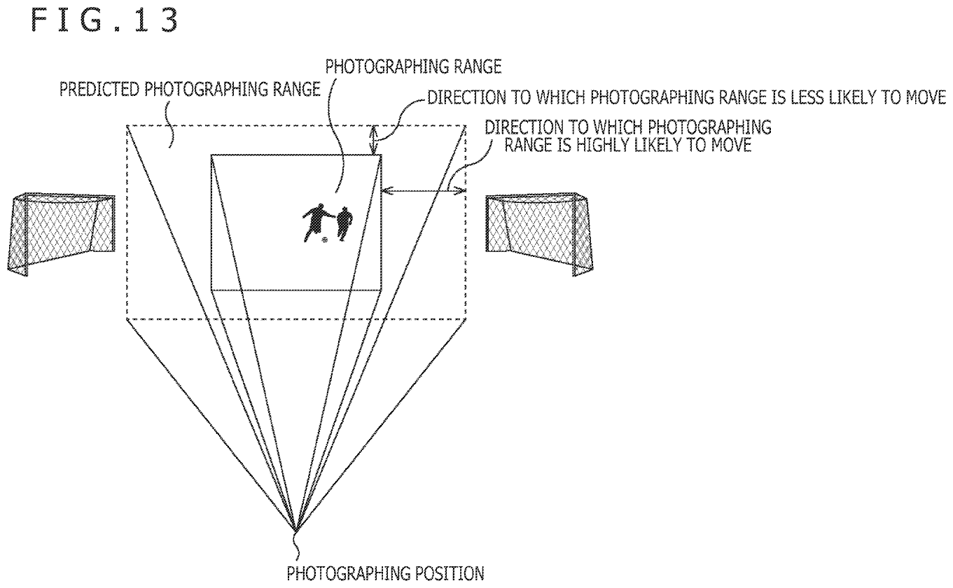

FIG. 13 is a diagram for explaining an example in which a predicted photographing range is set by the camera robot 20ₖ serving as a bird's-eye-view camera robot in FIG. 12.

The camera robot 20ₖ can set a predicted photographing range according to a photographing target of the camera robot 20ₖ.

For example, in a soccer game which is a photographing target of the camera robot 20ₖ, the likelihood that a soccer player and a soccer ball, which are subjects, move toward the direction of a goal in the soccer field is higher than the likelihood that the soccer player and the soccer ball move toward the direction of a sideline. Therefore, the photographing range of the camera robot 20ₖ is more likely to move toward the direction of a goal rather than the direction of a sideline.

Therefore, the camera robot 20ₖ can set a predicted photographing range according to the soccer game, the soccer player, the soccer ball, which are photographing targets for the camera robot 20ₖ.

For example, in a peripheral range of the photographing range, the camera robot 20ₖ can set, as a predicted photographing range, a range that is wider toward the direction of a goal to which the photographing range is highly likely to move and that is narrower toward the direction of a sideline to which the photographing range is less likely to move. Here, the action characteristics of a photographing action of the camera robot 20ₖ are affected by a photographing target of the camera robot 20ₖ. For example, since the camera robot 20ₖ serving as a bird's-eye-view camera robot photographs a wide range of the soccer field mainly centered on a player having a soccer ball from a bird's-eye view as explained previously, the camera robot 20ₖ has action characteristics of conducting only a parallel movement at a fixed height position. Setting a predicted photographing range according to a photographing target can be interpreted as setting a predicted photographing range according to the action characteristics of a photographing action of the camera robot 20ₖ which are affected by a photographing target.

It is to be noted that in a case where, in the peripheral range of the photographing range, a range that becomes wider toward the direction of a goal to which the photographing range is highly likely to move and that becomes narrower toward the direction of a sideline to which the photographing range is less likely to move is set as a predicted photographing range, as explained previously, the same obstruction cost having the same large value can be set for the photographing range and the predicted photographing range. In addition, an obstruction cost of a large value can be set for a position, in the photographing range and the predicted photographing range, close to the optical axis of the (camera 21ₖ of the) camera robot 20ₖ, and obstruction costs can be set such that the values thereof decrease from the optical axis toward the outside.

As explained so far, a predicted photographing range that becomes wider toward the direction of a goal is set according to the soccer game, etc., which is a photographing target of the camera robot 20ₖ, so that a photographing position and a movement path of the camera robot 20ᵢ, which is another camera robot to the camera robot 20ₖ, are set to avoid the predicted photographing range that becomes wider toward the direction of a goal. In this case, it can be considered that a photographing position and a movement path of the camera robot 20ᵢ are set according to the photographing target (or the action characteristics) of the camera robot 20ₖ.

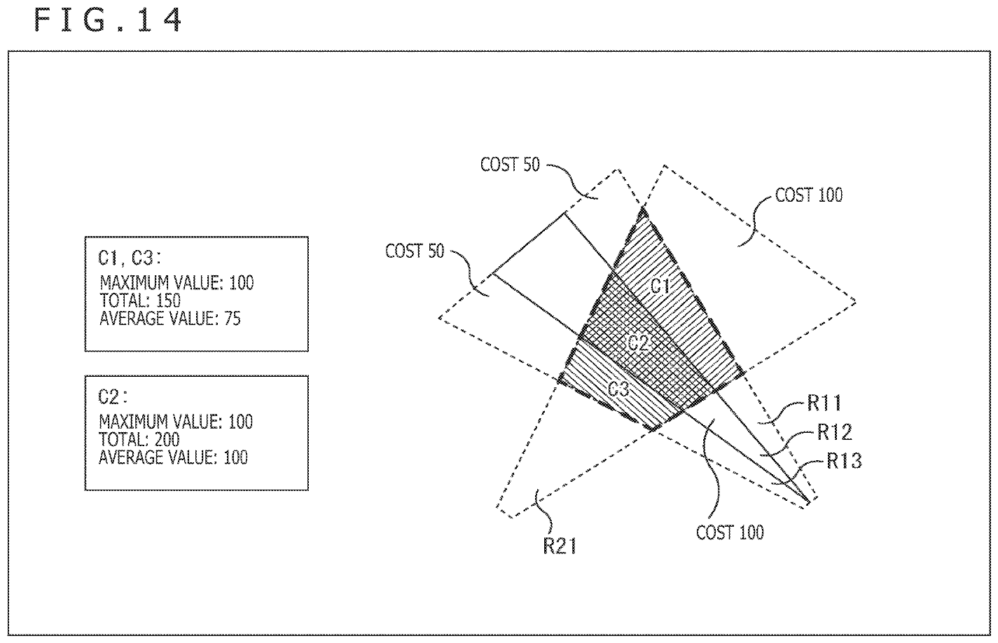

FIG. 14 is a diagram for explaining an example of combining of cost information at the cost information combining section 33.

In FIG. 14, cost information included in photographing information regarding two camera robots is depicted.

Cost information included in photographing information regarding one of the two camera robots includes range information indicating respective cost application ranges R11, R12, and R13, and obstruction costs of 50, 100, and 50 which are applied to the cost application ranges R11, R12, and R13, respectively. Cost information included in photographing information regarding the other camera robot includes range information indicating a cost application range R21, and an obstruction cost of 100 which is applied to the cost application range R21.

In cost information combining, the obstruction costs of the respective cost application ranges are combined together to obtain a combined cost. For an overlap range where plural cost application ranges overlap one another, the respective obstruction costs of the overlapping cost application ranges in the overlap range are combined to obtain a combined cost. Also, for a non-overlap range, in one cost application range, including no overlap with the other cost application ranges, the obstruction cost of the cost application range is directly obtained as a combined cost.

For example, the maximum value, the average value, the total, or the like, of the obstruction costs of the respective cost application ranges overlapping in the overlap range is obtained as a combined cost of the overlap range.

In FIG. 14, the cost application ranges R11, R12, and R13 overlap with the cost application range R21 in overlap ranges C1, C2, and C3, respectively.

In a case where the maximum value of the obstruction costs of the respective cost application ranges overlapping in an overlap range is adopted as a combined cost, the combined cost of each of the overlap ranges C1 to C3 is 100.

In a case where the total of the obstruction costs of the respective cost application ranges overlapping in an overlap range is adopted as a combined cost, the combined cost of each of the overlap ranges C1 and C3 and the combined cost of the overlap range C2 are 150 and 200, respectively.

In a case where the average value of the obstruction costs of the respective cost application ranges overlapping in an overlap range is adopted as a combined cost, the combined cost of each of the overlap ranges C1 and C3 and the combined cost of the overlap range C2 are 75 and 100, respectively.

In each of the cost application ranges R11, R12, and R13 and the cost application range R21, the obstruction cost of a range that does not overlap any other cost application range is directly adopted as the combined cost of the range that does not overlap any other cost application range.

According to the (combined cost information including the) aforementioned combined costs, a movement path or the like of the camera robot 20ᵢ is set such that the cumulative value of combined costs on the path becomes a global minimum or a local minimum, so that the camera robot 20ᵢ can be inhibited from obstructing photographing being performed by the other camera robot 20ₖ.

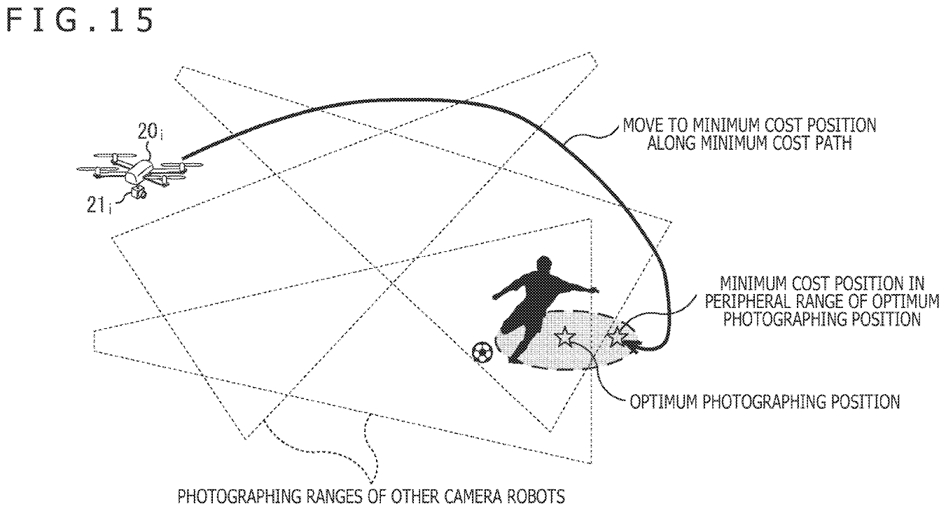

FIG. 15 is a diagram for explaining correcting an optimum photographing position.

In an optimum photographing position search as a photographing action plan, the camera robot 20ᵢ sets (searches for) an optimum photographing position that is optimum to track a subject which is assigned to be photographed by the camera robot 20ᵢ, for example. However, in a case where the optimum photographing position is disposed in the photographing range of the other camera robot 20ₖ, for example, the camera robot 20ᵢ obstructs photographing being performed by the other camera robot 20ₖ if moving to the optimum photographing position.

Therefore, the camera robot 20ᵢ can correct the optimum photographing position according to combined cost information.

To correct the optimum photographing position, the camera robot 20ᵢ conducts a minimum cost position search of searching for a position at which a combined cost is minimized in the peripheral range of the optimum photographing position by using combined cost information. Subsequently, the camera robot 20ᵢ corrects the optimum photographing position to the minimum cost position at which the combined cost is minimized in the peripheral range of the optimum photographing position.

Thereafter, the camera robot 20ᵢ sets a movement path of the camera robot 20ᵢ according to the combined cost information.

That is, the camera robot 20ᵢ conducts, as a photographing action plan, a search for a path which extends from the current position to the corrected optimum photographing position (minimum cost position) and on which the cumulative value of combined costs becomes a global minimum or a local minimum, by using combined cost information, and sets a movement path of the camera robot 20ᵢ to the path obtained by the search.

Then, the camera robot 20ᵢ conducts, as a photographing action, a movement along the movement path set by the photographing action plan.

In the manner explained so far, an optimum photographing position is corrected according to combined cost information, and a movement path is set, so that the camera robot 20ᵢ can be inhibited from obstructing photographing being performed by the other camera robot 20ₖ.

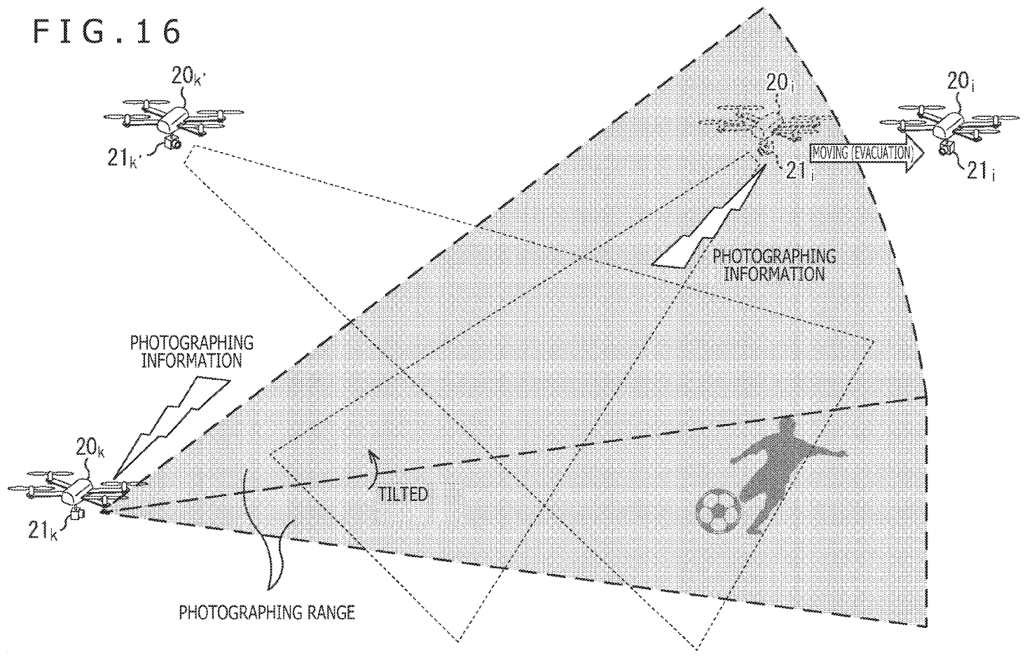

FIG. 16 is a diagram for explaining an example of a photographing action to inhibit the camera robot 20ᵢ from appearing in an image being photographed by the camera robot 20ₖ is conducted under the second photographing condition in FIG. 9.

In FIG. 16, the camera robots 20ᵢ and 20ₖ serving as bird's-eye-view camera robots as well as the camera robot 20ₖ serving as a ball-tracking camera robot each transmit photographing information regarding the camera robot itself.

The camera robot 20ᵢ receives photographing information regarding the other camera robots 20ₖ and 20ₖ except the camera robot 20ᵢ, and generates combined cost information by combining cost information included in the photographing information regarding the respective camera robots 20ₖ and 20_{k′}. Then, the camera robot 20ᵢ conducts a photographing action according to the combined cost information. That is, the camera robot 20ᵢ makes a photographing action plan according to the combined cost information, and conducts a movement, etc., as a photographing action according to the photographing action plan.

In the manner explained so far, a photographing action is conducted by the camera robot 20ᵢ according to the combined cost information. Thus, the camera robot 20ᵢ moves along a movement path to avoid any position in three-dimensional space to which obstruction costs each having a large value have been respectively set by the camera robots 20ₖ and 20_{k′}. Consequently, the camera robot 20ᵢ can be inhibited from appearing in an image being photographed by the camera robot 20ₖ (and an image being photographed by the camera robot 20_{k′}).

Under the second photographing condition, when a soccer ball which is a photographing target (subject) is kicked up, the camera robot 20ₖ serving as a ball-tracking camera robot is anticipated to upwardly tilt the camera 21ₖ in order to track the soccer ball.

Therefore, in a case where the photographing range of the camera robot 20ₖ serving as a ball-tracking camera robot is disposed near the ground, the camera robot 20ₖ sets, as a predicted photographing range, a range adjoining the upper side of the photographing range disposed near the ground, according to the soccer ball which is a photographing target, and sets an obstruction cost to be applied to the predicted photographing range.

The camera robot 20ᵢ, which makes a photographing action plan according to combined cost information, conducts a photographing action according to an obstruction cost that is applied to the predicted photographing range set by the camera robot 20ₖ. Thus, the camera robot 20ᵢ is inhibited from entering the predicted photographing range set by the camera robot 20ₖ. Further, in a case where the camera robot 20ᵢ has already entered the predicted photographing range set by the camera robot 20ₖ, the camera robot 20ᵢ conducts a movement as a photographing action to leave the predicted photographing range. As a result, even in a case where the camera robot 20ₖ upwardly tilts the camera 21ₖ and a part or the entire of the scheduled photographing range becomes a new photographing range, the camera robot 20ᵢ can be inhibited from appearing in an image being photographed by the camera robot 20ₖ and from obstructing photographing being performed by the camera robot 20ₖ.

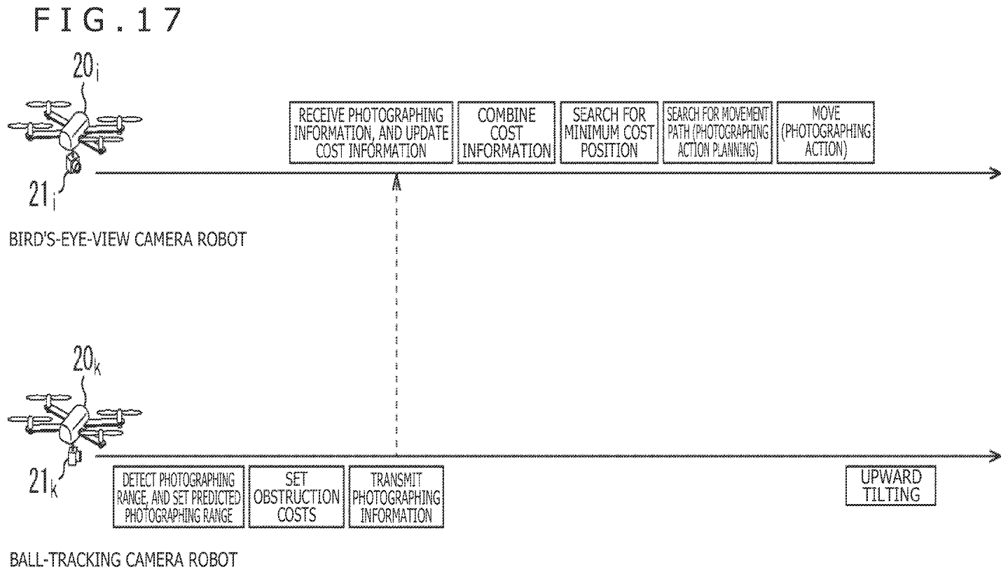

FIG. 17 is a diagram for explaining an example of processes at the camera robots 20ᵢ and 20ₖ in a case where a photographing action to inhibit the camera robot 20ᵢ from appearing in an image being photographed by the camera robot 20ₖ is conducted under the second photographing condition in FIG. 9.

The camera robot 20ₖ serving as a ball-tracking camera robot detects a photographing range, and sets a predicted photographing range. For example, in a case where the photographing range is disposed near the land, the camera robot 20ₖ serving as a ball-tracking camera robot sets, as a predicted photographing range, a range adjoining the upper side of the photographing range disposed near the ground, according to a soccer ball which is a photographing target.

Further, the camera robot 20ₖ sets one or more obstruction costs in the photographing range and the predicted photographing range, and generates cost information that includes the respective obstruction costs and includes range information indicating cost application ranges to which the obstruction costs are applied in the photographing range and the predicted photographing range.

Subsequently, the camera robot 20ₖ generates photographing information including the cost information, and transmits the photographing information.

Meanwhile, the camera robot 20ᵢ serving as a bird's-eye-view camera robot receives photographing information regarding camera robots including the camera robot 20ₖ but excluding the camera robot 20ᵢ, and updates cost information regarding the camera robots including the camera robot 20ₖ but excluding the camera robot 20ᵢ stored in the cost information DB 34, according to cost information included in the photographing information.

Thereafter, the camera robot 20ᵢ generates combined cost information by combining the cost information regarding the respective camera robots excluding the camera robot 20ᵢ stored in the cost information DB 34.

By using the combined cost information, the camera robot 20ᵢ conducts a minimum cost position search of searching for a position at which the combined cost is minimized in a peripheral range of an optimum photographing position that has been set (searched for) through a preliminary optimum photographing position search. Subsequently, the camera robot 20ᵢ corrects the optimum photographing position to a minimum cost position at which the combined cost is minimized in the peripheral range of the optimum photographing position such that the optimum photographing position is reset to the minimum cost position.

Further, by using the combined cost information, the camera robot 20ᵢ conducts, as photographing action planning, a search for a path which extends from the current position to the optimum photographing position and on which the cumulative value of combined costs becomes a global minimum or a local minimum, and sets, as a movement path of the camera robot 20ᵢ, the path obtained by the search.

Then, the camera robot 20ᵢ conducts, as a photographing action, a movement along the movement path set by the photographing action plan.

Thereafter, the (camera 21ₖ of the) camera robot 20ₖ serving as a ball-tracking camera robot is upwardly tilted to track the soccer ball in FIG. 17.

However, the camera robot 20ᵢ serving as a bird's-eye-view camera robot conducts a photographing action, according to the photographing range and the predicted photographing range set by the camera robot 20ₖ and according to combined cost information in which obstruction costs have been reflected. Accordingly, the camera robot 20ᵢ can be inhibited from entering the photographing range of the upwardly tilted camera robot 20ᵢ and from obstructing photographing being performed by the camera robot 20ₖ.

It is to be noted that, in the above explanation, the camera robot 20ᵢ conducts a photographing action according to combined cost information under the second photographing condition in FIG. 9 such that the camera robot 20ᵢ is inhibited from appearing in an image being photographed by the camera robot 20ₖ, but the camera robot 20ₖ may conduct a photographing actin according to photographing information regarding the camera robot 20ᵢ such that the camera robot 20ᵢ can be inhibited from appearing in an image being photographed by the camera robot 20ₖ.

That is, in some cases, the camera robot 20ᵢ that is located in a predicted photographing range set by the camera robot 20ₖ so as to adjoin the upper side of a photographing range disposed near the ground as illustrated in FIG. 16 is desired to preferentially continue photographing with the position set as a photographing position.

In this case, the camera robot 20ᵢ sets the current position (photographing position) to the photographing prohibition position, and transmits the photographing information including the photographing prohibition position.

The camera robot 20ₖ receives the photographing information regarding the camera robot 20ᵢ (and photographing information regarding another camera robot), makes a photographing action plan according to the photographing prohibition position included in the photographing information regarding the camera robot 20ᵢ, and takes the photographing action.

In this case, the camera robot 20ₖ performs photographing-prohibition-position photographing inhibition setting of inhibiting photographing of the photographing prohibition position included in the photographing information regarding the camera robot 20ᵢ (inhibiting the photographing prohibition position from being included in the photographing range of the camera robot 20ₖ).

Accordingly, the camera robot 20ₖ is inhibited from performing upward tilting that causes the position of the camera robot 20ᵢ (photographing prohibition position) to be included in the photographing range. As a result, the camera robot 20ᵢ can be inhibited from appearing in an image being photographed by the camera robot 20ₖ.

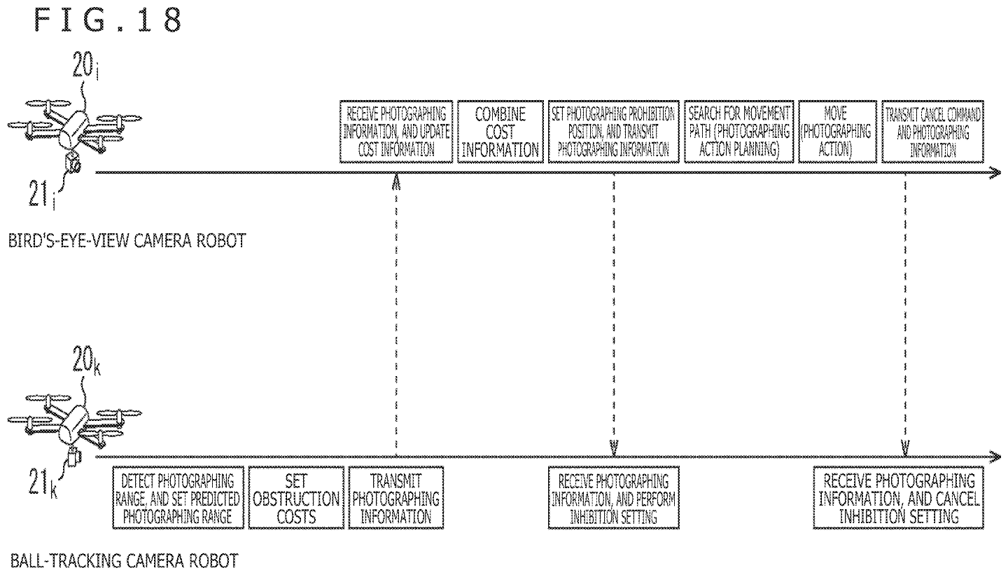

FIG. 18 is a diagram for explaining another example of processes at the camera robots 20ᵢ and 20ₖ in a case where a photographing action to inhibit the camera robot 20ᵢ from appearing in an image being photographed by the camera robot 20ₖ is conducted under the second photographing condition in FIG. 9.

That is, FIG. 18 is a diagram for explaining processes at the camera robots 20ᵢ and 20ₖ in a case where the camera robot 20ₖ conducts a photographing action according to a photographing prohibition position included in photographing information regarding the camera robot 20ᵢ such that the camera robot 20ᵢ is inhibited from appearing in an image being photographed by the camera robot 20ₖ.

As in the case in FIG. 17, the camera robot 20ₖ serving as a ball-tracking camera robot detects a photographing range, and sets a predicted photographing range. Further, the camera robot 20ₖ sets one or more obstruction costs in the photographing range and the predicted photographing range, and generates cost information that includes the respective obstruction costs and includes range information indicating cost application ranges to which the obstruction costs are applied in the photographing range and the predicted photographing range. Then, the camera robot 20ₖ generates photographing information including the cost information, and transmits the photographing information.

Meanwhile, as in the case in FIG. 17, the camera robot 20ᵢ serving as a bird's-eye-view camera robot receives photographing information regarding camera robots including the camera robot 20ₖ but excluding the camera robot 20ᵢ, and updates cost information regarding the camera robots including the camera robot 20ₖ but excluding the camera robot 20ᵢ stored in the cost information DB 34, according to cost information included in the photographing information. Furthermore, the camera robot 20ᵢ generates combined cost information by combining the cost information regarding the respective camera robots excluding the camera robot 20ᵢ stored in the cost information DB 34.

In a case where photographing at the current photographing position of the camera robot 20ᵢ is desired to be more preferentially performed than photographing by the other camera robots including the camera robot 20ₖ, the camera robot 20ᵢ sets the current photographing position as a photographing prohibition position, and transmits photographing information including the photographing prohibition position.

The camera robot 20ₖ receives the photographing information regarding the camera robot 20ᵢ, and performs photographing-prohibition-position photographing inhibition setting of inhibiting photographing of the photographing prohibition position according to the photographing prohibition position included in the photographing information.

Subsequently, the camera robot 20ₖ makes a photographing action plan for performing photographing of a subject from a preset optimum photographing position, and conducts a photographing action. However, due to the photographing-prohibition-position photographing inhibition setting, photographing of the photographing prohibition position that is included in the photographing range is inhibited.

Accordingly, when a soccer ball is kicked up with the camera robot 20ᵢ serving as a bird's-eye-view camera robot located above the photographing range of the camera robot 20ₖ serving as a ball-tracking camera robot, the camera robot 20ₖ is upwardly tilted such that a range where the photographing position of the camera robot 20ᵢ, which is a photographing prohibition position, is not included in the photographing range. As a result, the camera robot 20ᵢ can be inhibited from appearing in an image being photographed by the camera robot 20ₖ.

Thereafter, by using the combined cost information, the camera robot 20ᵢ conducts, as photographing action planning, a search for a path which extends from the current position to the optimum photographing position set by a preliminary optimum photographing position search and on which the cumulative value of combined costs becomes a global minimum or a local minimum, and sets, as a movement path of the camera robot 20ᵢ, the path obtained by the search.

Subsequently, the camera robot 20ᵢ conducts, as a photographing action, a movement along the movement path set by the photographing action plan.

As a result of the movement, the camera robot 20ᵢ leaves the photographing position set as the photographing prohibition position. Thus, the camera robot 20ᵢ generates a cancel command (command) for canceling the photographing-prohibition-position photographing inhibition setting, and transmits photographing information including the cancel command.

The camera robot 20ₖ receives the photographing information regarding the camera robot 20ᵢ, and cancels the photographing-prohibition-position photographing inhibition setting according to the cancel command included in the photographing information. Accordingly, the camera robot 20ₖ is permitted to perform photographing of a photographing range including the pre-movement photographing position of the camera robot 20ᵢ which is the former photographing prohibition position.

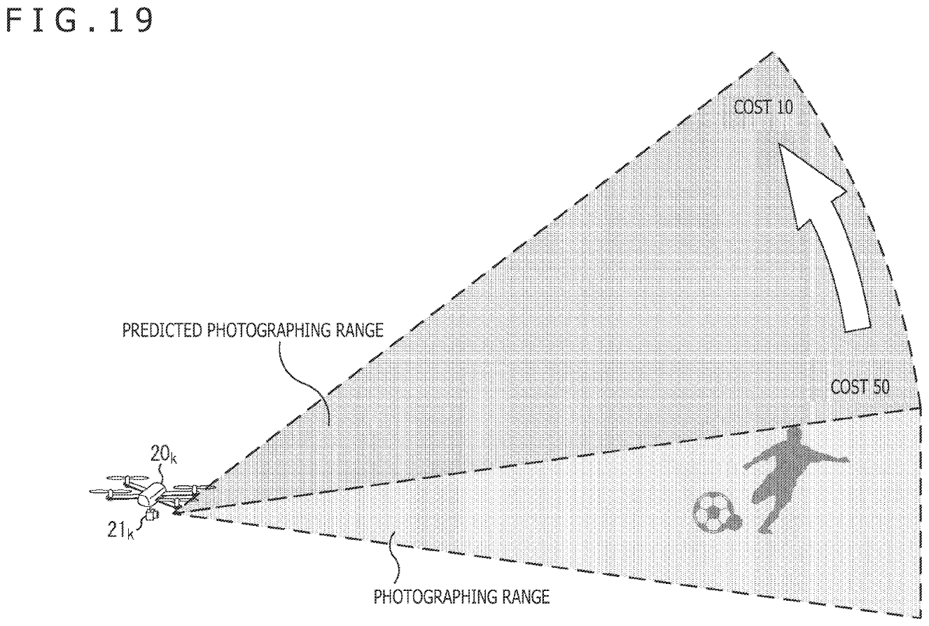

FIG. 19 is a diagram for explaining an example of a predicted photographing range and obstruction costs that are set by the camera robot 20ₖ serving as a ball-tracking camera robot according to a photographing target.

Photographing targets of the camera robot 20ₖ serving as a ball-tracking camera robot are a soccer game and a soccer ball.

In some cases, the soccer ball is kicked up from a point near the ground, and rises up into the air. Thus, in a case where the photographing range is near the ground because the soccer ball is located near the ground, the camera robot 20ₖ serving as a ball-tracking camera robot can set, as a predicted photographing range, a range that adjoins the upper side of the photographing range located near the ground, according to the soccer ball which is a photographing target, as illustrated in FIG. 19.

The camera robot 20ₖ serving as a ball-tracking camera robot can set an obstruction cost of a fixed value for the predicted photographing range adjoining the upper side of the photographing range located near the ground.

In addition, an obstruction cost can be set for the predicted photographing range of the camera robot 20ₖ, according to the soccer ball which is a photographing target of the camera robot 20ₖ.

For example, regarding a height to which the soccer ball which is a photographing target is kicked up, when the height is higher, the likelihood is estimated to be lower. Thus, in the predicted photographing range adjoining the upper side of the photographing range disposed near the ground, it is estimated that a location where the elevation angle with respect to the photographing position of the camera robot 20ₖ is smaller is more likely to become the photographing range, and, in contrast, a location where the elevation angle is larger is less likely to become the photographing range.

Therefore, an obstruction cost for the predicted photographing range of the camera robot 20ₖ serving as a ball-tracking camera robot can be set according to (kicking up) the soccer ball which is a photographing target such that, when the elevation angle is larger, the value of the obstruction cost becomes smaller, as depicted in FIG. 19. In FIG. 19, in the predicted photographing range, the obstruction cost at a position where the elevation angle is the smallest is 50. When the elevation angle becomes larger, the obstruction cost is decreased. In the predicted photographing range, the obstruction cost at a position where the elevation angle is the largest is 10.

In the manner explained so far, an obstruction cost in a predicted photographing range is set according to a soccer ball which is a photographing target, so that an obstruction cost of a large value is set for a location that is highly likely to become a photographing range. As a result, the camera robot 20ᵢ is inhibited from entering a position, in the predicted photographing range of the camera robot 20ₖ, that is highly likely to be included in the photographing range, and thus, the camera robot 20ᵢ can be inhibited from obstructing photographing being performed by the camera robot 20ₖ.

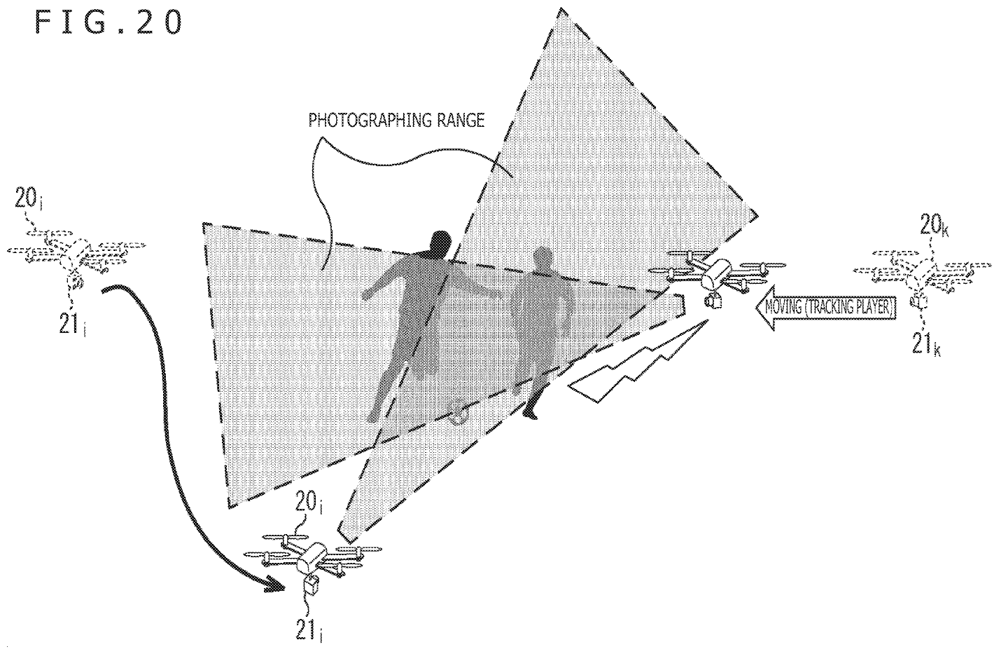

FIG. 20 is a diagram for explaining an example of photographing actions of inhibiting the camera robots 20ᵢ and 20ₖ to appear in each other's photographed images under the third photographing condition in FIG. 10.

In FIG. 20, the camera robot 20ᵢ serving as a ball-tracking camera robot and the camera robot 20ₖ serving as a player-tracking camera robot each transmit photographing information regarding the camera robot itself.

The camera robot 20ᵢ receives photographing information regarding the other camera robots including the camera robot 20ₖ, and generates combined cost information by combining cost information included in the photographing information.

Subsequently, the camera robot 20ᵢ conducts a photographing action according to the combined cost information. That is, the camera robot 20ᵢ makes a photographing action plan according to the combined cost information, and conducts a movement, etc., as a photographing action according to the photographing action plan.

Like the camera robot 20ᵢ the camera robot 20ₖ also receives the photographing information regarding the other camera robots including the camera robot 20ᵢ, and generates combined cost information by combining cost information included in the photographing information. Subsequently, the camera robot 20ₖ conducts a photographing action according to the combined cost information.

In the manner explained so far, the camera robots 20ᵢ and 20ₖ each conduct a photographing action according to combined cost information. Thus, the camera robots 20ᵢ and 20ₖ each move along a movement path to avoid any position in a three-dimensional space to which an obstruction cost of a large value has been set by any of the other camera robots. Consequently, the camera robots 20ᵢ and 20ₖ can be inhibited from appearing in each other's photographed images.

In a case where the camera robots 20ᵢ and 20ₖ each conduct a movement (including an attitude control) as a photographing action according to combined cost information, a state where the camera robots 20ᵢ and/or 20ₖ having conducted the movement can appear in the other's photographed image or each other's photographed images may occur.

In this case, the camera robots 20ᵢ and 20ₖ can repeat the photographing action according to the combined cost information until the state where the camera robots 20ᵢ and/or 20ₖ having conducted the movement appear in the other's photographed image or each other's photographed images is canceled.

Alternatively, a camera robot (hereinafter, also referred to as a preferred camera robot), between the camera robots 20ᵢ and 20ₖ, that preferentially performs photographing is set, and the preferred camera robot can set, as a photographing prohibition position, the photographing position of the preferred camera robot and transmit photographing information including the photographing prohibition position to the other camera robots.

In this case, the other camera robots (camera robots except the preferred camera robot) each conduct a photographing action so as not to photograph the photographing prohibition position (such that the photographing prohibition position is not included in any of the photographing ranges).

In FIG. 19, between the camera robot 20ᵢ serving as a ball-tracking camera robot and the camera robot 20ₖ serving as a player-tracking camera robot, the camera robot 20ₖ, for example, is set as a preferred camera robot, and the camera robot 20ₖ transmits photographing information that includes cost information and the photographing position of the camera robot 20ₖ, which is the photographing prohibition position.

Then, the camera robot 20ᵢ which is not a preferred camera robot in FIG. 19 receives the photographing information transmitted from the camera robot 20ₖ, and conducts a photographing action to track and photograph a soccer ball, according to the photographing information, so as not to photograph the position of the camera robot 20ₖ which is the photographing prohibition position and so as to travel around (sneaks around) the photographing range of the camera robot 20ₖ.

In the manner explained so far, the camera robots 20ᵢ and 20ₖ are inhibited from appearing in each other's photographed images in FIG. 19.

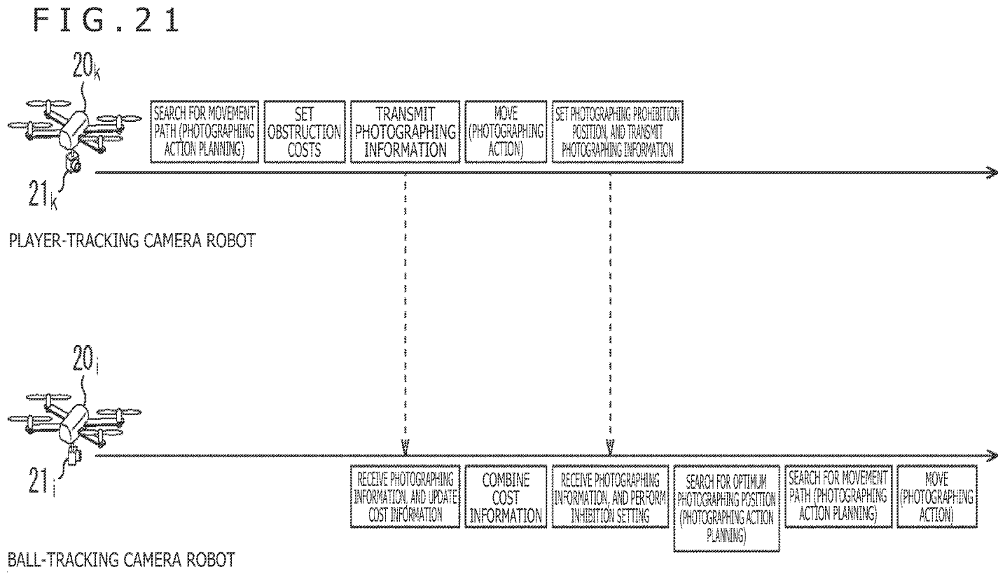

FIG. 21 is a diagram for explaining processes at the camera robots 20ᵢ and 20ₖ in a case where the camera robots 20ᵢ and 20ₖ each conduct a photographing action to inhibit from appearing in each other's photographed images under the third photographing condition in FIG. 10.

Here, it is assumed that, between the camera robot 20ᵢ serving as a ball-tracking camera robot and the camera robot 20ₖ serving as a player-tracking camera robot, the camera robot 20ₖ is set as a preferred camera robot.

The camera robot 20ₖ which is a preferred camera robot and serves as a player-tracking camera robot conducts, as photographing action planning, a movement path search of searching for a path to be set as a movement path, and sets a predicted photographing range according to a movement path obtained by the movement path search. Further, the camera robot 20ₖ sets obstruction costs according to the movement path of the camera robot 20ₖ.

Here, in the movement path search, a subject prediction of predicting a movement of a soccer player who is a subject being tracked by the camera robot 20ₖ is made, and a path for tracking the soccer player is retrieved as a movement path on the basis of the prediction result of the subject prediction.

Subsequently, the camera robot 20ₖ sets, as a predicted photographing range, a range that is highly likely to become a photographing range, according to the movement path, and an obstruction cost of a large value is set for a range, in the expected photographing range, that is highly likely to become a photographing range.

Therefore, setting a predicted photographing range and obstruction costs according to a movement path can be considered as setting a predicted photographing range and obstruction costs according to a photographing target (here, a soccer player which is a subject) of the camera robot 20ₖ.

The camera robot 20ₖ sets one or more obstruction costs in the photographing range and the predicted photographing range, and generates cost information that includes the obstruction costs and includes range information indicating cost application ranges to which the obstruction costs are applied. Subsequently, the camera robot 20ₖ generates photographing information including the cost information, and transmits the photographing information.

The camera robot 20ᵢ serving as a ball-tracking camera robot receives photographing information regarding camera robots including the camera robot 20ₖ but excluding the camera robot 20ᵢ, and updates cost information regarding the camera robots including the camera robot 20ₖ but excluding the camera robot 20ᵢ stored in the cost information DB 34, according to cost information included in the photographing information.

Thereafter, the camera robot 20ᵢ generates combined cost information by combining the cost information regarding the respective camera robots excluding the camera robot 20ᵢ stored in the cost information DB 34.

The camera robot 20ₖ which is a preferred camera robot and serves as a player-tracking camera robot conducts a photographing action of moving along the movement path obtained by the movement path search. Then, at a position reached after the movement along the movement path, the camera robot 20ₖ sets the current position (photographing position) as a photographing prohibition position, if needed. In a case of setting a photographing prohibition position, the camera robot 20ₖ transmits photographing information including the photographing prohibition position.

The camera robot 20ᵢ receives the photographing information regarding the camera robot 20ₖ, makes a photographing action plan according to the photographing prohibition position included in the photographing information, and conducts a photographing action.

In this case, photographing-prohibition-position photographing inhibition setting of inhibiting photographing of the photographing prohibition position included in the photographing information regarding the camera robot 20ₖ is performed at the camera robot 20ᵢ.

Accordingly, the camera robot 20ᵢ is inhibited from conducting a photographing action that involves a situation in which the position of the camera robot 20ₖ (photographing prohibition position) is included in the photographing range. As a result, the camera robot 20ₖ can be inhibited from appearing in an image being photographed by the camera robot 20ᵢ.

The camera robot 20ᵢ conducts, as photographing action planning, an optimum photographing position search of searching for an optimum photographing position to track a soccer ball.

However, in the optimum photographing position search as the photographing action planning at the camera robot 20ᵢ, a position at which the photographing prohibition position is included in the photographing range is inhibited from being retrieved as an optimum photographing position during soccer ball tracking, through the photographing-prohibition-position photographing inhibition setting.

The camera robot 20ᵢ conducts, as photographing action planning, a search (movement path search) for a path which extends from the current position to the optimum photographing position and on which the cumulative value of combined costs becomes a global minimum or a local minimum, by using the combined cost information, and sets, as a movement path of the camera robot 20ᵢ, the path obtained by the search. However, in the movement path search as photographing action planning at the camera robot 20ᵢ, a path that causes a situation in which the photographing prohibition position is included in the photographing range during a movement along the path is inhibited from being retrieved, through the photographing-prohibition-position photographing inhibition setting.

Thereafter, the camera robot 20ᵢ conducts, as a photographing action, a movement along the movement path set by the photographing action plan.

In the manner explained so far, the camera robot 20ᵢ serving as a ball-tracking camera robot sets (searches for) an optimum photographing position and a movement path such that, through the photographing-prohibition-position photographing inhibition setting, the photographing prohibition position by the camera robot 20ₖ serving as a player-tracking camera is prevented from being included in the photographing range.

Consequently, the camera robot 20ₖ can be inhibited from appearing in an image being photographed by the camera robot 20ᵢ.

Furthermore, the camera robot 20ᵢ serving as a ball-tracking camera robot conducts a movement path search according to combined cost information in which cost information regarding the camera robot 20ₖ serving as a player-tracking camera has been reflected, and conducts a movement as a photographing action according to the movement path obtained by the movement path search. Consequently, during the movement conducted as a photographing action by the camera robot 20ᵢ according to the movement path, the camera robot 20ᵢ can be inhibited from appearing in an image being photographed by the camera robot 20ₖ.

In the manner explained so far, the camera robots 20ᵢ and 20ₖ can be inhibited from appearing in each other's photographed images.

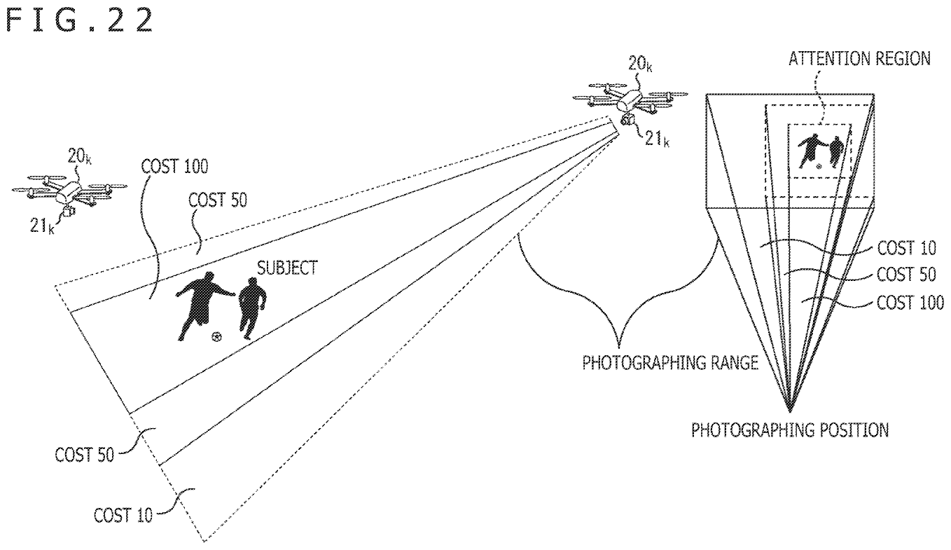

FIG. 22 is a diagram for explaining obstruction cost setting according to an attention region.

For example, in a case where the camera robot 20ₖ serves as a bird's-eye-view camera robot, the camera robot 20ₖ performs wide-range photographing. In a photographed image (hereinafter, also referred to as a wide-range image) obtained by the wide-range photographing, a user who is a viewer pays attention to a soccer ball or a soccer player having the ball. Therefore, even when the camera robot 20ᵢ which is a camera robot other than the camera robot 20ₖ appears, in a wide-range image, at a position apart from a soccer ball or a soccer player to which a user is paying attention, the user viewing the wide-range image is less likely to become aware of the appearance of the camera robot 20ᵢ.

Accordingly, it is not considered that the sense of realism is significantly impaired.

Therefore, for example, the camera robot 20ₖ can set, as an attention region, a prescribed range including a subject in an image being photographed by the camera robot 20ₖ, and set obstruction costs according to the attention region.

To set the attention region, for example, a predetermined subject is detected from an image being photographed by the camera robot 20ₖ, and a rectangular range including the subject can be set as the attention region. Alternatively, for example, a subject to which a user viewing a photographed image is paying attention is detected in the photographed image on the basis of the visual line of the user, and a rectangular region including the subject can be set as the attention region.

To set obstruction costs according to the attention region, for example, an obstruction cost of a large value can be set for a range that is projected to the attention region in a photographing range (and a predicted photographing range), and an obstruction cost of a medium value can be set for a range that is projected to a peripheral range of the attention region.

Further, an obstruction cost of a small value can be set for a range that is projected to a more peripheral range of the peripheral range of the attention region in the photographing range.

In the photographing range in FIG. 22, an obstruction cost of 100 is set for a range that is projected to the attention region, an obstruction cost of 50 is set for a range that is projected to a peripheral range of the attention region, and an obstruction cost of 10 is set for a range that is projected to a more peripheral range of the peripheral range of the attention region.

It is to be noted that, in FIG. 22, the obstruction costs are changed stepwise with the distance from the attention region, but the obstruction costs may be continuously changed.

In the manner explained so far, the camera robot 20ₖ sets obstruction costs according to an attention region, so that setting a photographing position and a movement path to cause the other camera robot 20ᵢ to appear at a position apart from the attention region in an image being photographed by the camera robot 20ₖ is allowed. As a result, the camera robot 20ᵢ can efficiently and flexibly conduct a photographing action such as a movement (conducts a movement or the like along an efficient movement path) while being substantially inhibited from obstructing photographing being performed by the camera robot 20ₖ.

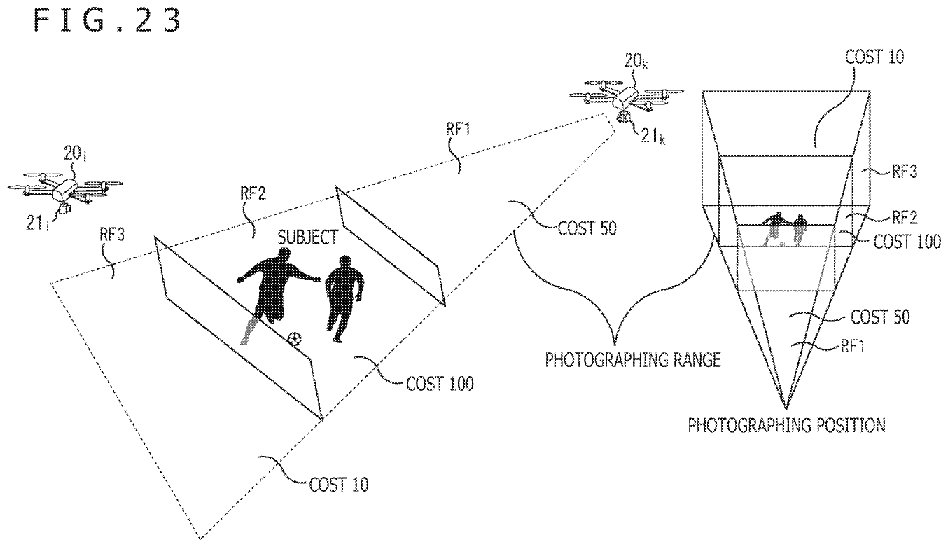

FIG. 23 is a diagram for explaining setting obstruction costs according to a focal distance.

For example, in a case where the camera robot 20ₖ is a player-tracking camera robot, a player may be photographed in a telescopic manner from a position avoiding a relatively wide photographing range of the bird's-eye-view camera robot. In a case where telephotography is performed, that is, in a case where the focal distance of the camera 21ₖ is long, the depth of field is shallow. In a case where the focal distance of the camera 21ₖ is short, the depth of field is deep.

In a case where the depth of field is shallow, the camera robot 20ᵢ enters an out-of-focus state upon slightly leaving a focus position. Even when the camera robot 20ᵢ which is the other camera robot except the camera robot 20ₖ appears in an image being photographed by the camera robot 20ₖ during the out-of-focus state, a user viewing the photographed image is less likely to become aware of the camera robot 20ᵢ in the image.

Accordingly, it is not considered that the sense of realism is significantly impaired.

Therefore, the camera robot 20ₖ can set obstruction costs according to the focal distance of the camera 21ₖ.

Here, when the camera robot 20ᵢ enters a range RF2 which is expanded, in the photographing range of the camera robot 20ₖ, from a position that is close, by a prescribed distance, to the near side from the range of the depth of field to a position that is immediately behind the range of the depth of field, the camera robot 20ᵢ in a focused state or in a nearly focused state comes to appear in an image being photographed by the camera robot 20ₖ. That is, the camera robot 20ᵢ in a very conspicuous state appears in an image being photographed by the camera robot 20ₖ.

In addition, when the camera robot 20ᵢ enters a range RF1 which is expanded, in the photographing range of the camera robot 20ₖ, from the photographing position of the camera robot 20ₖ to a position that is close, by a prescribed distance, to the near side from the range of the depth of field, the camera robot 20ᵢ in a blurred state comes to appear in an image being photographed by the camera robot 20ₖ. However, in this case, the camera robot 20ᵢ appears to be large in size on a near side relative to the soccer player who is a subject being tracked by the camera robot 20ₖ when viewed from the camera robot 20ₖ serving as a player-tracking camera robot. Thus, the camera robot 20ᵢ may obstruct viewing a soccer player who is appearing in an image being photographed by the camera robot 20ₖ.

In contrast, in a case where the camera robot 20ᵢ enters a range RF3 which is expanded, in the photographing range of the camera robot 20ₖ, to the far side from the position immediately behind the range of the depth of field, the camera robot 20ᵢ that is in a blurred state and that is small in size comes to appear on the far side from a soccer player who is a subject being tracked by the camera robot 20ₖ serving as a player-tracking camera robot. Thus, the camera robot 20ᵢ rarely obstructs viewing a soccer player appearing in an image being photographed by the camera robot 20ₖ.

Accordingly, to set obstruction costs according to a focal distance, an obstruction cost of a large value can be set for the range RF2 which is expanded, in the photographing range (and the predicted photographing range), from a position that is close, by the prescribed distance, to the near side from the range of the depth of field, which is determined according to a focal distance, to a position that is immediately behind the range of the depth of field, for example. Furthermore, a medium obstruction cost can be set for the range RF1 which is expanded, in the photographing range, from the photographing position of the camera robot 20ₖ to a position that is close, by the prescribed distance, to the range of the depth of field, which is determined according to the focal distance, for example.

Moreover, an obstruction cost of a small value can be set for the range RF3 which is expanded, in the photographing range, to the far side from the position immediately behind the range of the depth of field, which is determined according to the focal distance.

In the photographing range in FIG. 23, an obstruction cost of 50 is set for the range RF1, an obstruction cost of 100 is set for the range RF2, and an obstruction cost of 10 is set for the range RF3.

It is to be noted that, the obstruction costs in FIG. 23 are changed stepwise, but the obstruction costs may be continuously changed, for example, so as to be decreased with an increase in the distance from the focusing position.

In the manner explained so far, the camera robot 20ₖ sets obstruction costs according to a focal distance, so that the other camera robot 20ᵢ is permitted to set a photographing position and a movement path on the far side in the range of the depth of field of the camera 21ₖ of the camera robot 20ₖ. As a result, the camera robot 20ᵢ can efficiently and flexibly conduct a photographing action such as a movement while being substantially inhibited from obstructing photographing being performed by the camera robot 20ₖ.

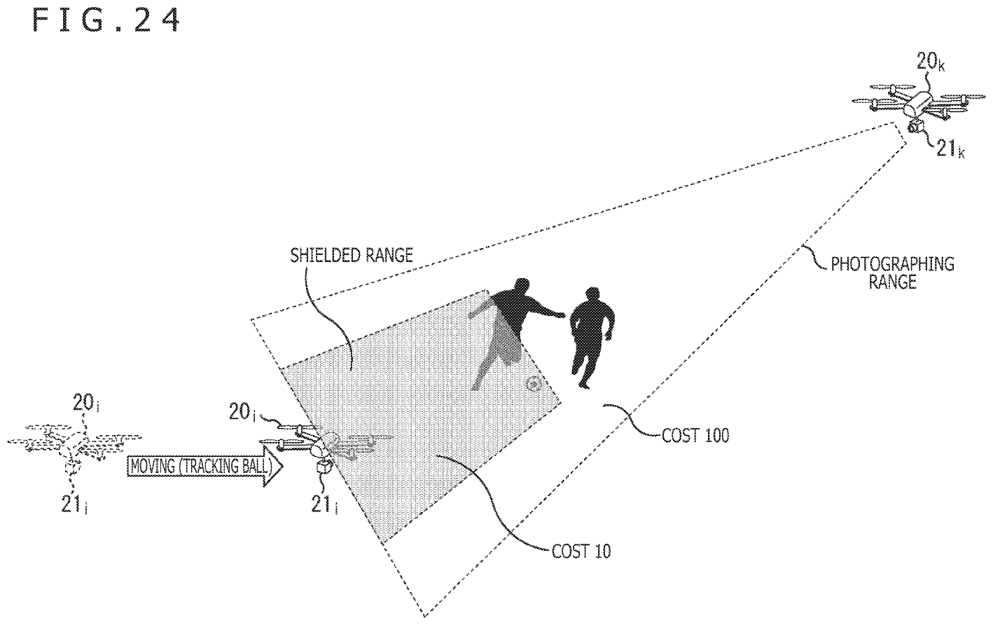

FIG. 24 is a diagram for explaining setting obstruction costs according to a shielded range.

Even in the photographing range and the predicted photographing range of the camera robot 20ₖ, a shielded range which is a dead angle to the photographing position of the (camera 21ₖ of the) camera robot 20ₖ exists, in some cases, because the camera robot 20ₖ may be hidden by a soccer player or a ball, which is a subject being tracked by the camera robot 20ₖ, and a soccer goal, an umpire, etc.

Even when the camera robot 20ᵢ enters the shielded range, the camera robot 20ᵢ does not obstruct photographing being performed by the camera robot 20ₖ because the shielded range is not reflected in an image being photographed by the camera robot 20ₖ.

Therefore, the camera robot 20ₖ can set obstruction costs according to the shielded range. For example, the camera robot 20ₖ can set, for the shielded range, an obstruction cost of a small value including 0.

In FIG. 24, an obstruction cost of 100 is set for a range except the shielded range in the photographing range, and an obstruction cost of 10 is set for the shielded range.

The camera robot 20ₖ sets obstruction costs according to the shielded range in the aforementioned manner, so that the other camera robot 20ᵢ is permitted to set a photographing position and a movement path in the shielded range. As a result, in a case where, for example, the camera robots 20ᵢ and 20ₖ face each other, the camera robot 20ᵢ avoids appearing in an image being photographed by the camera robot 20ₖ and approaches a subject that is being tracked by the camera robot 20ᵢ, so that the camera robot 20ᵢ can effectively photograph the subject.

It is to be noted that the camera robot 20ₖ can obtain the shielded range by recognizing the shape of a shielding object with a stereo camera or a ranging sensor such as a ToF sensor or a LIDAR, for example, and by detecting, on the basis of the shape of the shielding object, a range that is a dead angle to the photographing position of the camera robot 20ₖ.

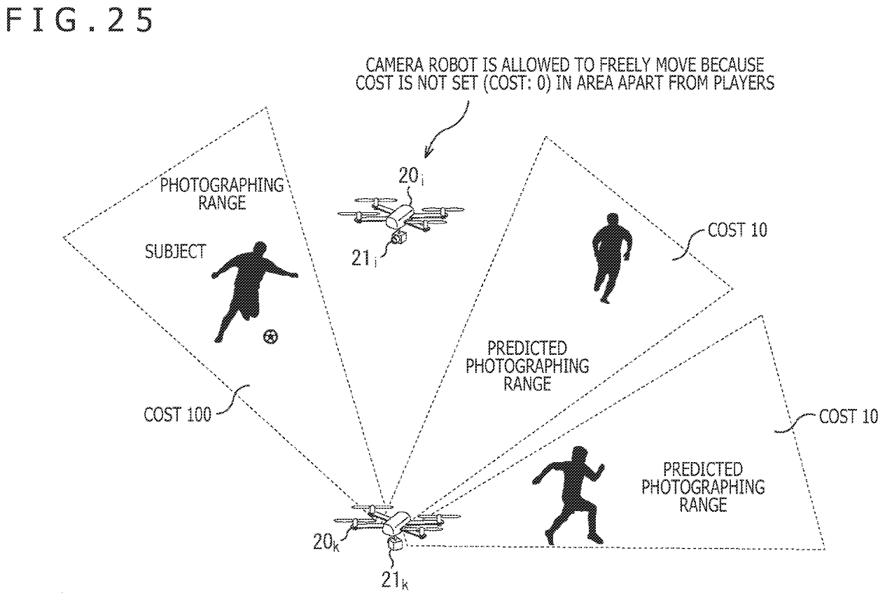

FIG. 25 is a diagram for explaining a case in which a range apart from a photographing range is set as a predicted photographing range.

As explained previously with reference to FIGS. 13 and 16, etc., the camera robot 20ₖ can set, as a predicted photographing range, a range adjoining the photographing range of the camera robot 20ₖ (e.g., a peripheral range of the photographing range, a range adjoining the upper side of the photographing range, or the like) according to a photographing target, or can set, as a predicted photographing range, what is called a discontinuous range that is apart from the photographing range.

For example, in a soccer game, a soccer player who is paid attention to (a soccer player who is having the soccer ball) (hereinafter, also referred to as an attention player) may be changed by a pass or an offense-defense change.

In a case where the attention player passes a ball to a near soccer player and the soccer player having caught the pass becomes a new attention player, the photographing range of the camera robot 20ₖ serving as a player-tracking camera robot is unchanged from the pre-pass photographing range, or, if changed, still includes a part of the pre-pass photographing range.

In a case where an attention player passes a long ball to a remote soccer player and the soccer player having caught the pass becomes a new attention player, the photographing range of the camera robot 20ₖ serving as a player-tracking camera robot is a discontinuous range that is apparat from the pre-pass photographing range.

That is, in this case, the camera robot 20ₖ in a state of photographing the pre-pass attention player conducts a photographing action of performing large and high-speed (horizontal) panning in order to photograph the post-pass attention player. Then, during the panning of the camera robot 20ₖ, the photographing range continuously changes. However, in a case where the camera robot 20ₖ serving as a player-tracking camera robot performs the aforementioned high-speed panning, photographing of the photographing range being performed by the camera robot 20ₖ during the high-speed panning is not for causing the camera robot 20ₖ to track a soccer player. In addition, the camera robot 20ₖ is intended to perform photographing of the pre-pass attention player and photographing of the post-pass attention player. Therefore, in a case where the camera robot 20ₖ performs high-speed panning as a photographing action, it can be considered that the photographing range of the camera robot 20ₖ is substantially changed discontinuously from the photographing range to photograph the pre-pass attention player to the photographing range to photograph the post-pass attention player.

Furthermore, in a case where the camera robot 20ₖ performs large panning, the post-panning photographing range becomes a discontinuous range that does not adjoin the pre-panning photographing range.

In a case where passing a long ball is performed, the aforementioned high-speed large panning is performed at the camera robot 20ₖ according to a soccer game and a soccer player which are photographing targets. In view of this, the camera robot 20ₖ can set, as a predicted photographing range, a range that becomes a photographing range when a soccer player who is a subject located outside the current photographing range, that is, a soccer player who can receive the ball from the attention player, is photographed.

In this case, when a soccer player is located at a position very far from the attention player, a range that includes the position of the soccer player and that is apparat from the current photographing range is set as a predicted photographing range.

In FIG. 25, a range that is apart from the (current) photographing range is set as a predicted photographing range.

An obstruction cost of 100 is set for the photographing range, and an obstruction cost of 10, which is less than the obstruction cost of 100 for the photographing range, is set for the predicted photographing range.

In FIG. 25, a range that is sandwiched between the photographing range and the predicted photographing range and that is neither a photographing range nor a predicted photographing range becomes a photographing range during high-speed panning in a case where the high-speed panning is conducted as a photographing action by the camera robot 20ₖ. Even when the other camera robot 20ᵢ is located in such a range that becomes a photographing range during high-speed panning, photographing being performed by the camera robot 20ₖ is less affected. Here, the expression that photographing being performed by the camera robot 20ₖ is less affected means that, even when the other camera robot 20ᵢ appears in a photographed image during high-speed panning of the camera robot 20ₖ, a user is substantially not (hardly) inhibited from viewing the photographed image because it is difficult for the user viewing the photographed image to recognize the appearance of the other camera robot 20ᵢ in the photographed image.

Accordingly, in a case where, as a predicted photographing range, a discontinuous range that is apart from the photographing range is set at the camera robot 20ₖ, the other camera robot 20ᵢ is permitted to set a photographing position and a movement path in a range that is sandwiched between the photographing range and the predicted photographing range of the camera robot 20ₖ and is set as neither a photographing range nor a predicted photographing range, or in a range that is sandwiched between predicted photographing ranges of the camera robot 20ₖ and is set as neither a photographing range nor a predicted photographing range. Thus, the camera robot 20ᵢ can efficiently and flexibly conduct a photographing action such as a movement while being substantially inhibited from obstructing photographing being performed by the camera robot 20ₖ.

It is to be noted that, in the present embodiment, obstruction costs are set in a photographing range and a predicted photographing range, and thus, no obstruction cost is set for any range outside the photographing range and the predicted photographing range. A range for which no obstruction cost is set can be regarded as a predicted photographing range to which an obstruction cost of 0 is applied.

As explained so far, in the photographing system in FIG. 1, each of the camera robots 20ᵢ transmits photographing information including information regarding a photographing range being photographed by the camera 21₁, receives photographing information including information regarding the photographing ranges of the other camera robots 20ᵢ and controls a photographing action for performing photographing by means of the camera 21ᵢ, according to the photographing information regarding the other camera robots 20ₖ.

Consequently, the camera robots 20₁ to 20₅ can each autonomously conduct a photographing action so as not to cause mutual obstruction of photographing.

Moreover, as explained previously with reference to FIGS. 13 and 16, for example, each of the camera robots 20ᵢ sets a predicted photographing range and obstruction costs, etc., according to a photographing target or according to the action characteristics of a photographing action for photographing the photographing target, and transmits photographing information including the predicted photographing range and the obstruction costs. Further, each of the camera robots 20ᵢ receives photographing information regarding the other camera robots 20ₖ, and makes a photographing action plan according to the photographing information. Therefore, a photographing position, an attitude, and a movement path that hardly affect mutual photographing and that are efficient can be set.

In addition, as explained previously with reference to FIG. 25, for example, each of the camera robots 20ᵢ sets, as a predicted photographing range, a range that becomes a photographing range when a subject that is currently located outside the photographing range is photographed, and transmits photographing information including the predicted photographing range. Further, each of the camera robots 20ᵢ receives photographing information regarding the other camera robots 20ₖ, and conducts a photographing action (after making a photographing action plan) according to the photographing information. Therefore, according to a discontinuous change of the photographing range of any of the other camera robots 20ₖ, the camera robot 20ᵢ can conduct an efficient photographing action so as not to obstruct photographing being performed by the other camera robots 20ₖ.

### <Explanation of Computer to Which Present Technique Is Applied>

Next, the aforementioned series of processes can be executed by hardware, and can also be executed by software. In a case where the series of processes is executed by software, a program included in the software is installed into a general-purpose computer or the like.

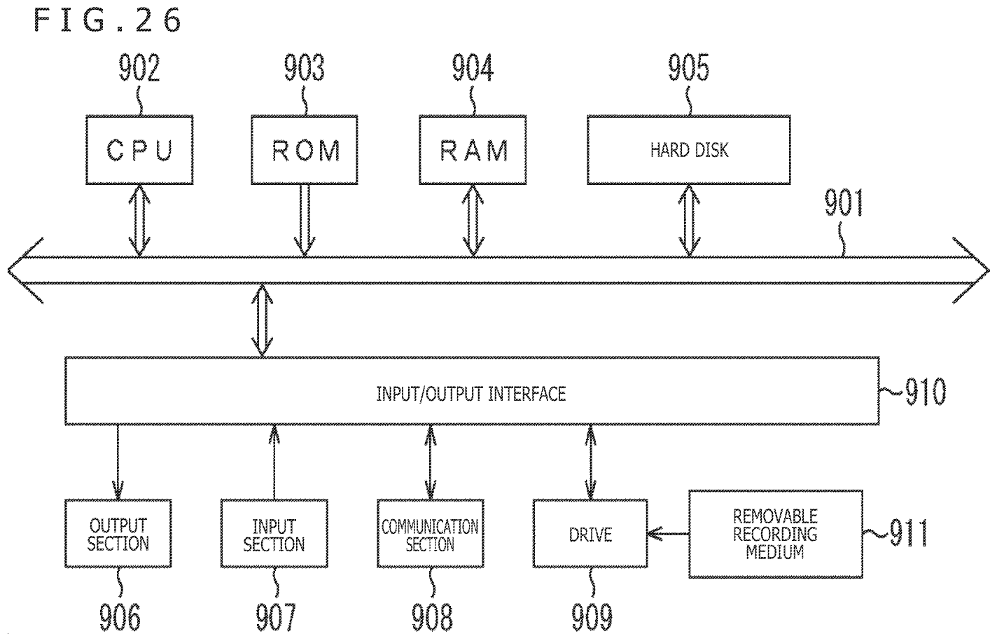

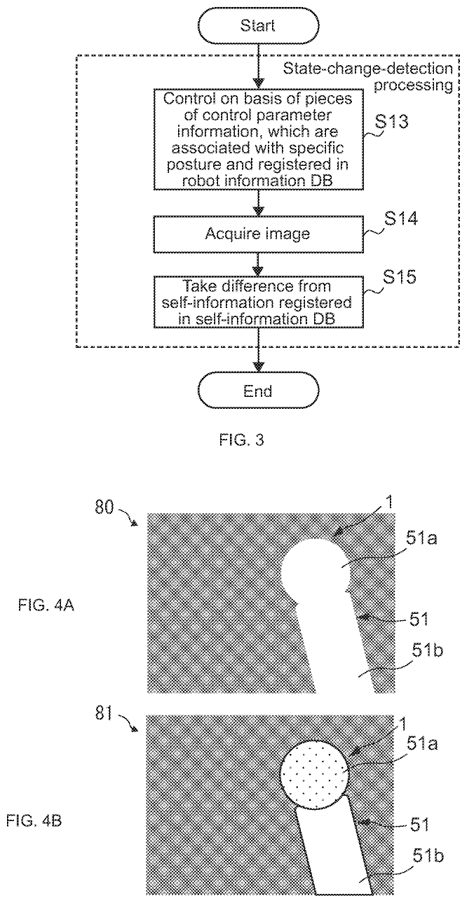

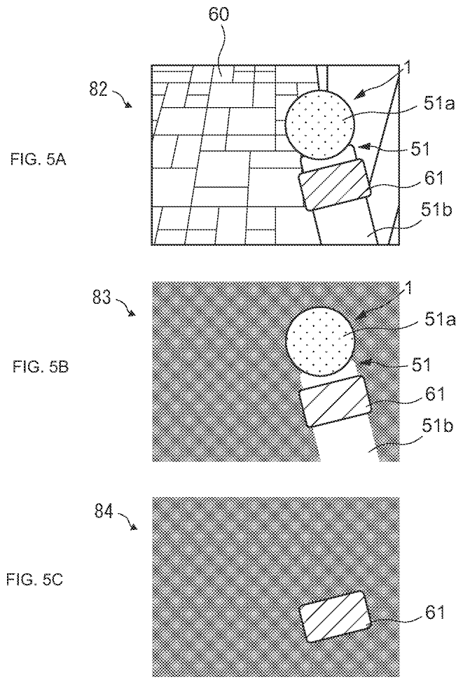

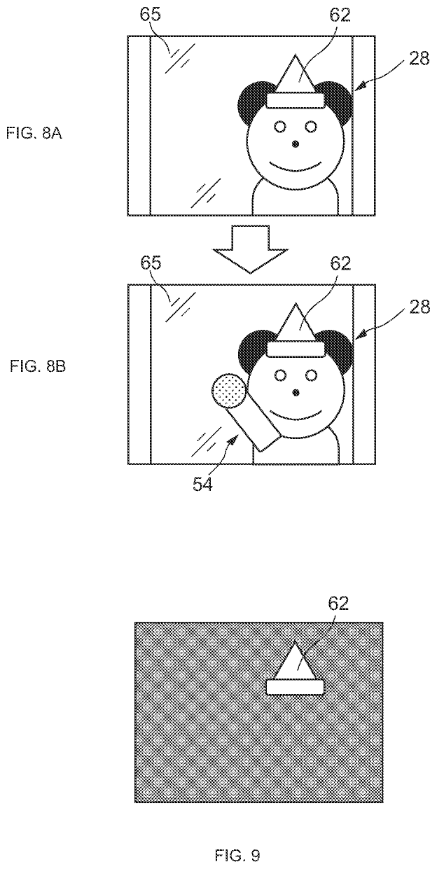

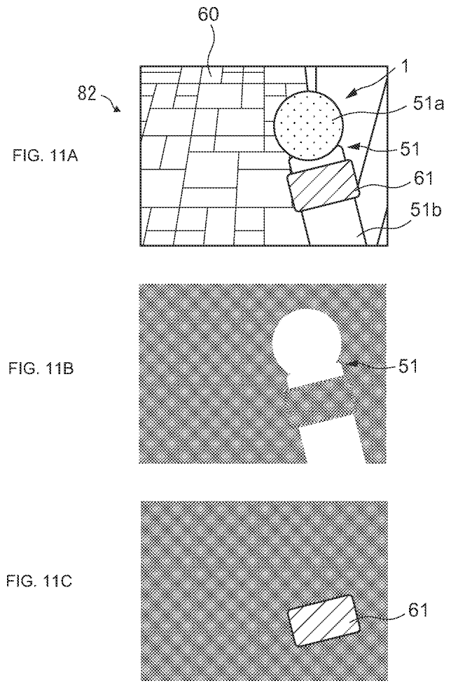

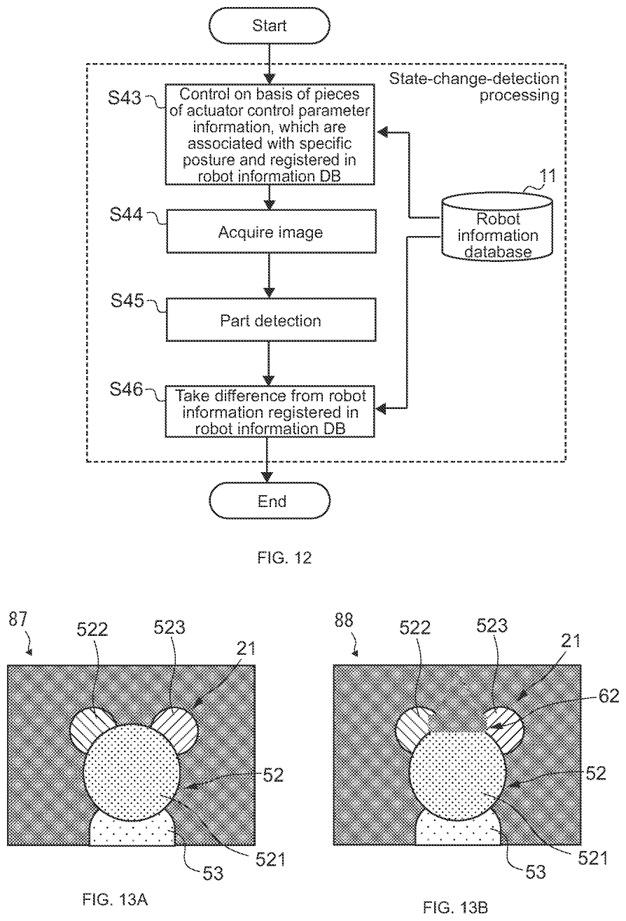

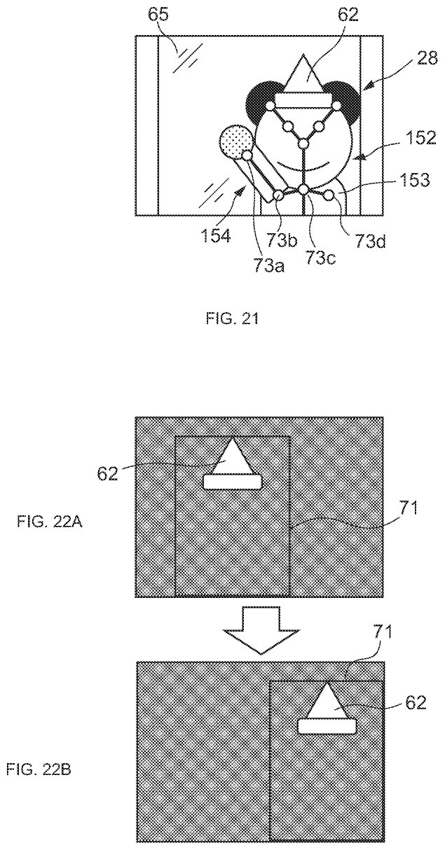

FIG. 26 is a diagram depicting a configuration example of one embodiment of a computer into which the program for executing the aforementioned series of processes is installed.

The program can be preliminarily recorded in a ROM 903 or a hard disk 905 which is a recording medium incorporated in the computer.

Alternatively, the program can be stored (recorded) in a removable recording medium 911 that is driven by a drive 909. The removable recording medium 911 can be provided as what is called package software. Here, a flexible disc, a CD-ROM (Compact Disc Read Only Memory), an MO (Magneto Optical) disc, a DVD (Digital Versatile Disc), a magnetic disc, a semiconductor memory, or the like can be used as the removable recording medium 911, for example.

It is to be noted that the program can be installed into the computer from the aforementioned removable recording medium 911, or can be downloaded to the computer over a communication network or broadcasting network and be installed into the incorporated hard disk 905. That is, the program can be wirelessly transferred from a download site to the computer via an artificial satellite for digital satellite broadcasting, for example, or can be transferred to the computer by wire over a LAN (Local Area Network) or a network such as the internet.

A CPU (Central Processing Unit) 902 is incorporated in the computer, and an input/output interface 910 is connected to the CPU 902 via a bus 901.

When a user operates an input section 907 via the input/output interface 910 to input a command, the CPU 902 executes the program stored in the ROM (Read Only Memory) 903 according to the command. Alternatively, the CPU 902 loads the program stored in the hard disk 905 into a RAM (Random Access Memory) 904, and executes the program.

Thus, the CPU 902 performs the process according to the aforementioned flowchart, or processes which are performed by the components in the aforementioned block diagrams. Thereafter, for example, the CPU 902 outputs the result of the process from an output section 906 via the input/output interface 910 or transmits the result from a communication section 908, and further records the result into the hard disk 905, if needed.

It is to be noted that the input section 907 includes a keyboard, a mouse, a microphone, or the like. Also, the output section 906 includes an LCD (Liquid Crystal Display), a loudspeaker, or the like.

In the present description, processes to be executed by the computer according to the program do not always need to be executed in the time-series order that has been explained in the flowcharts. That is, the processes to be executed by the computer according to the program also include processes (e.g., parallel processes or processes by an object) to be parallelly or separately executed.

In addition, the program may be processed by one computer (processor), or may be processed by multiple computers in a distributed manner. Furthermore, the program may be executed after being transferred to a remote computer.

Moreover, in the present description, a system means a set of multiple constituent components (devices, modules (components), etc.), and whether or not all the constituent components are included in the same casing does not matter. Therefore, a set of multiple devices that are housed in separate casings and are connected to one another over a network is a system, and further, a single device having multiple modules housed in a single casing is also a system.

It is to be noted that the embodiment according to the present technique is not limited to the aforementioned embodiment, and various modifications can be made within the scope of the gist of the present technique.

For example, the present technique can be configured by cloud computing in which one function is shared and cooperatively processed by multiple devices over a network.

Furthermore, the respective steps explained in the aforementioned flowcharts can be executed by a single device, or can be executed cooperatively by multiple devices.

Also, in a case where multiple processes are included in one step, the multiple processes included in the one step can be executed by a single device, or can be executed cooperatively by multiple devices.

It is to be noted that the effects set forth in the present description are just examples, and are not limitative. Thus, any other effect may be provided.

### REFERENCE SIGNS LIST

20₁ to 20₅ Camera robot, 21₁ to 21₅ Camera, 31 Sensor, 32 Cost information deriving section, 33 Cost information combining section, 34 Cost information DB, 35 Photographing action planning section, 36 Photographing action control section, 37 Camera driving section, 38 Robot driving section, 39 Communication section, 901 Bus, 902 CPU, 903 ROM, 904 RAM, 905 Hard disk, 906 Output section, 907 Input section, 908 Communication section, 909 Drive, 910 Input/output interface, 911 Removable recording medium

1. A mobile body comprising:
a communication section that receives photographing information including information regarding a photographing range that is photographed by another mobile body; and
a photographing action control section that controls a photographing action of a camera according to the photographing information regarding the other mobile body received by the communication section.

2. The mobile body according to claim 1, further comprising:
a cost information deriving section that generates the photographing information including an obstruction cost and range information, the obstruction cost being set for a photographing range of the mobile body and representing a likelihood that the other mobile body obstructs photographing being performed by the mobile body, the range information indicating a cost application range to which the obstruction cost is applied in the photographing range.

3. The mobile body according to claim 2, wherein
the cost information deriving section generates the photographing information including an obstruction cost and range information, the obstruction cost being set for a predicted photographing range that is predicted to become the photographing range of the mobile body, the range information indicating a cost application range to which the obstruction cost is applied in the predicted photographing range.

4. The mobile body according to claim 3, wherein
the photographing action control section controls the photographing action according to a combined cost that is obtained by combining the obstruction cost included in the photographing information regarding the other mobile body.

5. The mobile body according to claim 4, wherein
the photographing action control section causes a movement of the mobile body to a corrected photographing position that is obtained through a correction according to the combined cost.

6. The mobile body according to claim 5, wherein
the photographing action control section causes a movement of the mobile body to the corrected photographing position, along a movement path that is set according to the combined cost.

7. The mobile body according to claim 3, wherein
the cost information deriving section sets the predicted photographing range according to a photographing target of the camera.

8. The mobile body according to claim 3, wherein
the cost information deriving section sets the obstruction cost according to a photographing target of the camera.

9. The mobile body according to claim 3, wherein
the cost information deriving section sets the obstruction cost according to an attention region that is set in the photographing range of the mobile body.

10. The mobile body according to claim 3, wherein
the cost information deriving section sets the obstruction cost according to a focal distance of the camera.

11. The mobile body according to claim 3, wherein
the cost information deriving section sets, as the predicted photographing range, a range that becomes the photographing range when a subject located outside the photographing range of the mobile body is photographed.

12. The mobile body according to claim 3, wherein
the cost information deriving section sets a photographing prohibition position at which the other mobile body's photographing is prohibited, and generates the photographing information including the photographing prohibition position.

13. The mobile body according to claim 12, wherein
the photographing action control section inhibits photographing of the photographing prohibition position included in the photographing information regarding the other mobile body.

14. The mobile body according to claim 3, wherein
the cost information deriving section sets the obstruction cost according to a shielded range that includes a dead angle to the camera.

15. The mobile body according to claim 1, wherein
the mobile body includes a drone.

16. A control method comprising:
by a mobile body,
receiving photographing information including information regarding a photographing range that is photographed by another mobile body; and
controlling a photographing action of a camera according to the photographing information regarding the other mobile body.
